(19) United States
(12) Patent Application Publication
(10) Pub. No.: US 2024/0314761 A1
(43) Pub. Date: Sep. 19, 2024

(54) COMMUNICATION METHOD AND APPARATUS

(71) Applicant: HUAWEI TECHNOLOGIES CO., LTD., Shenzhen (CN)

(72) Inventors: Xiuqiang Xu, Shanghai (CN); Lei Wang, Shanghai (CN); Fan Wei, Shenzhen (CN); Yan Chen, Ottawa (CA)

(73) Assignee: HUAWEI TECHNOLOGIES CO., LTD., Shenzhen (CN)

(21) Appl. No.: 18/679,304

(22) Filed: May 30, 2024

Related U.S. Application Data
(63) Continuation of application No. PCT/CN2022/134466, filed on Nov. 25, 2022.

(30) Foreign Application Priority Data
Nov. 30, 2021 (CN) 202111447353.2

(51) Int. Cl. H04W 72/115; H04W 28/26; H04W 72/044

(52) U.S. Cl. CPC H04W 72/115; H04W 28/26; H04W 72/044

(57) ABSTRACT

A communication method for reducing resource overheads and improving decoding efficiency, is applied to a communication system. The method includes: a terminal device sends resource reservation information, where the resource reservation information is used to reserve a grant-free resource; and the terminal device sends data on an actually reserved grant-free resource.

### CROSS-REFERENCE TO RELATED APPLICATIONS

This application is a continuation of International Application No. PCT/CN2022/134466, filed on Nov. 25, 2022, which claims priority to Chinese Patent Application No. 202111447353.2, filed on Nov. 30, 2021. The disclosures of the aforementioned applications are hereby incorporated by reference in their entireties.

### TECHNICAL FIELD

This disclosure relates to the communication field, and in particular, to a communication method and apparatus.

### BACKGROUND

A dynamic grant-free (GF) technology can implement uplink data transmission without requiring a dynamic grant from a network device, and therefore has features of low resource overheads, low power consumption of a terminal device, and a low latency.

Currently, data may be transmitted based on a configured grant-free resource. Specifically, a network device may configure a grant-free resource and a transmission parameter by using higher layer signaling, for example, a system message (SI) or terminal device-specific (e.g. UE-specific) radio resource control (RRC) signaling. A terminal device may send data on the grant-free resource based on a data sending requirement. For example, when sending a random access preamble or a physical uplink shared channel (PUSCH), the terminal device may send data by using the grant-free resource, and the network device does not need to dynamically configure a resource, thereby reducing signaling overheads and improving data transmission efficiency.

However, in the foregoing grant-free transmission solution, a grant-free resource used to transmit data is randomly selected by the terminal device. In this way, when the network device performs blind detection, complexity of blind detection is high, and a workload is heavy. Consequently, resource overheads are high, and decoding efficiency is low.

### SUMMARY

Embodiments of this disclosure provide a communication method and apparatus, to resolve problems of high resource overheads and low decoding efficiency.

To achieve the foregoing objective, this disclosure uses the following technical solutions.

According to a first aspect, a communication method is provided. The communication method includes: A terminal device sends resource reservation information, where the resource reservation information is used to reserve a grant-free resource; and the terminal device sends data on an actually reserved grant-free resource.

Based on the communication method provided in the first aspect, the terminal device may send the resource reservation information to a network device to reserve the grant-free resource, and send data on the actually reserved grant-free resource. In this way, the network device may receive data from the terminal device based on the grant-free resource actually reserved by the terminal device. For example, the network device may receive data from the terminal device on the grant-free resource actually reserved by the terminal device, to avoid performing blind detection on all grant-free resources. This can reduce a quantity of blind detection times and reduce complexity of blind detection, so as to reduce a workload of blind detection, thereby reducing resource overheads and improving decoding efficiency.

In a solution, the resource reservation information may be carried in one or more of the following: control signaling, a control channel, or a data channel, that is, the resource reservation information may be transmitted in an explicit manner.

In another solution, the resource reservation information may be associated with one or more of the following: a time domain resource, a frequency domain resource, a space domain resource, a beam domain resource, a code domain resource, a sequence resource, or a power domain resource, that is, the resource reservation information may also be transmitted in an implicit manner. In this way, when the resource reservation information is sent, an additional time-frequency resource may be avoided from being occupied, and the resource reservation information is implicitly indicated, so as to reduce resource overheads, thereby further improving efficiency.

It should be noted that the resource reservation information may be further transmitted by combining an explicit manner and an implicit manner. For example, one part of the resource reservation information may be transmitted in an explicit manner, and the other part may be transmitted in an implicit manner. In this way, flexibility may be improved.

In a solution, the resource reservation information is used to reserve a first resource in the grant-free resource. Before the terminal device sends the data on the actually reserved grant-free resource, the communication method provided in the first aspect may further include: The terminal device receives reservation result information, where the reservation result information indicates that the first resource is successfully reserved. That the terminal device sends data on an actually reserved grant-free resource may include: The terminal device sends the data on the first resource. In this way, when the first resource is successfully reserved, the terminal device can send data on the first resource, so that a probability that the terminal device sends data on a resource that conflicts with that of another terminal device can be reduced to reduce interference between terminal devices and increase a decoding success rate of the network device, thereby improving reliability and efficiency.

In another solution, the resource reservation information is used to reserve a first resource in the grant-free resource. Before the terminal device sends the data on the actually reserved grant-free resource, the communication method according to the first aspect may further include: The terminal device receives reservation result information, where the reservation result information includes reservation failure indication information of the first resource and availability indication information, the availability indication information indicates a second resource, and the second resource is an available grant-free resource, that is, an idle resource in the grant-free resource. That the terminal device sends data on an actually reserved grant-free resource may include: The terminal device sends the data on the second resource. In this way, the terminal device may receive the reservation result information, and send data on the second resource when the reservation result information indicates that the first resource fails to be reserved, for example, the first resource has been reserved or occupied by another terminal device. The network device may coordinate, by using the reservation result information, grant-free resources actually reserved by different terminal devices, so that a probability that the terminal device sends data on a resource that conflicts with that of another terminal device can be reduced to reduce interference between terminal devices and increase a decoding success rate of the network device, thereby improving reliability and efficiency.

In still another solution, the resource reservation information is used to reserve a first resource in the grant-free resource. Before the terminal device sends the data on the actually reserved grant-free resource, the communication method provided in the first aspect may further include: The terminal device receives reservation result information, where the reservation result information includes reservation failure indication information of the first resource. That the terminal device sends data on an actually reserved grant-free resource may include: The terminal device sends the data on a third resource, where the third resource is a resource in the grant-free resource other than the first resource. In this way, when the first resource is unavailable, the third resource may be used to send data, so that a probability that the terminal device sends data on a resource that conflicts with that of another terminal device can be reduced to reduce interference between terminal devices and increase a decoding success rate of the network device, thereby improving reliability and efficiency.

Optionally, the reservation result information may be carried in one or more of the following: control signaling, a control channel, or a data channel, that is, the reservation result information may be transmitted in an explicit manner.

Alternatively, the reservation result information may be associated with one or more of the following: a time domain resource, a frequency domain resource, a space domain resource, a beam domain resource, a code domain resource, a sequence resource, or a power domain resource, that is, the reservation result information may also be transmitted in an implicit manner. In this way, when the reservation result information is sent, an additional time-frequency resource may be avoided from being occupied, and the reservation result information is implicitly indicated, so as to reduce resource overheads, thereby further improving efficiency.

It should be noted that the reservation result information may be further transmitted by combining an explicit manner and an implicit manner. For example, one part of the reservation result information may be transmitted in an explicit manner, and the other part of the reservation result information may be transmitted in an implicit manner. In this way, flexibility may be improved.

In a solution, the resource reservation information is used to reserve a first resource in the grant-free resource. Before the terminal device sends the data on the actually reserved grant-free resource, the communication method provided in the first aspect may further include: The terminal device sends first reservation cancellation information, where the first reservation cancellation information indicates a resource, whose reservation is canceled, in the first resource. That the terminal device sends data on an actually reserved grant-free resource may include: The terminal device sends the data on a fourth resource, where the fourth resource is an available resource other than the resource whose reservation is canceled in the grant-free resource. In this way, the terminal device may perform grant-free transmission based on a usage status of the first resource. For example, when the first resource is used for grant-based transmission, the terminal device may send data on an available resource, that is, the fourth resource, so that a probability that the terminal device sends data on a resource that conflicts with that of another terminal device can be reduced to reduce interference between terminal devices and increase a decoding success rate of the network device, thereby further improving reliability.

Optionally, the first reservation cancellation information may be carried in one or more of the following: control signaling, a control channel, or a data channel, that is, the first reservation cancellation information may be transmitted in an explicit manner.

Alternatively, the first reservation cancellation information may be associated with one or more of the following: a time domain resource, a frequency domain resource, a space domain resource, a beam domain resource, a code domain resource, a sequence resource, or a power domain resource, that is, the first reservation cancellation information may also be transmitted in an implicit manner, to reduce resources and improve efficiency.

It should be noted that the first reservation cancellation information may be further transmitted by combining an explicit manner and an implicit manner. For example, one part of the first reservation cancellation information may be transmitted in an explicit manner, and the other part of the first reservation cancellation information may be transmitted in an implicit manner. In this way, flexibility may be improved.

In a solution, the resource reservation information is used to reserve a first resource in the grant-free resource. Before the terminal device sends the data on the actually reserved grant-free resource, the communication method according to the first aspect may further include: The terminal device receives second reservation cancellation information, where the second reservation cancellation information indicates a resource, whose reservation is canceled, in the first resource. That the terminal device sends data on an actually reserved grant-free resource may include: The terminal device sends the data on a fifth resource, where the fifth resource is a resource in a provided resource other than the resource whose reservation is canceled. In this way, the terminal device may perform grant-free transmission based on a usage status of the first resource. For example, when the first resource corresponding to the terminal device conflicts with a grant-free resource reserved by another terminal device, the conflicting resource may be canceled, and data may be sent on an available resource, that is, the fifth resource, so that a probability that the terminal device sends data on a resource that conflicts with that of another terminal device can be reduced to reduce interference between terminal devices and decrease a decoding success rate of the network device, thereby improving reliability.

Optionally, the second reservation cancellation information may be carried in one or more of the following: control signaling, a control channel, or a data channel, that is, the second reservation cancellation information may be transmitted in an explicit manner.

Alternatively, the second reservation cancellation information may be associated with one or more of the following: a time domain resource, a frequency domain resource, a space domain resource, a beam domain resource, a code domain resource, a sequence resource, or a power domain resource, that is, the second reservation cancellation information may also be transmitted in an implicit manner.

It should be noted that the second reservation cancellation information may be further transmitted by combining an explicit manner and an implicit manner. For example, one part of the second reservation cancellation information may be transmitted in an explicit manner, and the other part of the second reservation cancellation information may be transmitted in an implicit manner. In this way, flexibility may be improved.

In a solution, the actually reserved grant-free resource is related to a status of a resource in the grant-free resource.

According to a second aspect, a communication method is provided. The communication method includes: A network device receives resource reservation information, where the resource reservation information is used to reserve a grant-free resource; and the network device receives data on an actually reserved grant-free resource.

In a solution, the resource reservation information may be carried in one or more of the following: control signaling, a control channel, or a data channel, that is, the resource reservation information may be transmitted in an explicit manner.

In another solution, the resource reservation information may be associated with one or more of the following: a time domain resource, a frequency domain resource, a space domain resource, a beam domain resource, a code domain resource, a sequence resource, or a power domain resource, that is, the resource reservation information may also be transmitted in an implicit manner.

It should be noted that the resource reservation information may be further transmitted by combining an explicit manner and an implicit manner. For example, one part of the resource reservation information may be transmitted in an explicit manner, and the other part of the resource reservation information may be transmitted in an implicit manner.

In a solution, the resource reservation information is used to reserve a first resource in the grant-free resource. Before the network device receives the data on the actually reserved grant-free resource, the communication method according to the second aspect may further include: The network device sends reservation result information, where the reservation result information indicates that the first resource is successfully reserved. That the network device receives data on an actually reserved grant-free resource may include: The network device receives the data on the first resource.

In another solution, the resource reservation information is used to reserve a first resource in the grant-free resource. Before the network device receives the data on the actually reserved grant-free resource, the communication method according to the second aspect may further include: The network device sends reservation result information, where the reservation result information includes reservation failure indication information of the first resource and availability indication information, the availability indication information indicates a second resource, and the second resource is an available grant-free resource. That the network device receives data on an actually reserved grant-free resource may include: The network device receives the data on the second resource.

In still another solution, the resource reservation information is used to reserve a first resource in the grant-free resource. Before the network device receives the data on the actually reserved grant-free resource, the communication method according to the second aspect may further include: The network device sends reservation result information, where the reservation result information includes reservation failure indication information of the first resource. That the network device receives data on an actually reserved grant-free resource may include: The network device receives the data on a third resource, where the third resource is a resource in the grant-free resource other than the first resource.

Optionally, the reservation result information may be carried in one or more of the following: control signaling, a control channel, or a data channel, that is, the reservation result information may be transmitted in an explicit manner.

Alternatively, the reservation result information may be associated with one or more of the following: a time domain resource, a frequency domain resource, a space domain resource, a beam domain resource, a code domain resource, a sequence resource, or a power domain resource, that is, the reservation result information may also be transmitted in an implicit manner.

It should be noted that the reservation result information may be further transmitted by combining an explicit manner and an implicit manner. For example, one part of the reservation result information may be transmitted in an explicit manner, and the other part of the reservation result information may be transmitted in an implicit manner.

In a solution, the resource reservation information is used to reserve a first resource in the grant-free resource. Before the network device receives the data on the actually reserved grant-free resource, the communication method according to the second aspect may further include: The network device receives first reservation cancellation information, where the first reservation cancellation information indicates a resource, whose reservation is canceled, in the first resource. That the network device receives data on an actually reserved grant-free resource may include: The network device receives the data on a fourth resource, where the fourth resource is a resource in the grant-free resource other than the resource whose reservation is canceled.

Optionally, the first reservation cancellation information may be carried in one or more of the following: control signaling, a control channel, or a data channel, that is, the first reservation cancellation information may be transmitted in an explicit manner.

Alternatively, the first reservation cancellation information may be associated with one or more of the following: a time domain resource, a frequency domain resource, a space domain resource, a beam domain resource, a code domain resource, a sequence resource, or a power domain resource, that is, the first reservation cancellation information may also be transmitted in an implicit manner.

It should be noted that the first reservation cancellation information may be further transmitted by combining an explicit manner and an implicit manner. For example, one part of the first reservation cancellation information may be transmitted in an explicit manner, and the other part of the first reservation cancellation information may be transmitted in an implicit manner.

In a solution, the resource reservation information is used to reserve a first resource in the grant-free resource. Before the network device receives the data on the actually reserved grant-free resource, the communication method according to the second aspect may further include: The network device sends second reservation cancellation information, where the second reservation cancellation information indicates a resource, whose reservation is canceled, in the first resource. That the network device receives data on an actually reserved grant-free resource may include: The network device receives the data on a fifth resource, where the fifth resource is a resource in the grant-free resource other than the resource whose reservation is canceled.

Optionally, the second reservation cancellation information may be carried in one or more of the following: control signaling, a control channel, or a data channel, that is, the second reservation cancellation information may be transmitted in an explicit manner.

Alternatively, the second reservation cancellation information may be associated with one or more of the following: a time domain resource, a frequency domain resource, a space domain resource, a beam domain resource, a code domain resource, a sequence resource, or a power domain resource, that is, the second reservation cancellation information may also be transmitted in an implicit manner.

It should be noted that the second reservation cancellation information may be further transmitted by combining an explicit manner and an implicit manner. For example, one part of the second reservation cancellation information may be transmitted in an explicit manner, and the other part of the second reservation cancellation information may be transmitted in an implicit manner.

In a solution, the actually reserved grant-free resource is related to a status of a resource in the grant-free resource.

In addition, for technical effects of the communication method in the second aspect, refer to the technical effects of the communication method in the first aspect. Details are not described herein again.

According to a third aspect, a communication method is provided. The communication method includes: A terminal device receives idle indication information, where the idle indication information indicates an available grant-free resource; and the terminal device sends data on the grant-free resource indicated by the idle indication information.

Based on the communication method provided in the third aspect, a network device sends the idle indication information to indicate the grant-free resource corresponding to the terminal device. In this way, the network device may receive data on the grant-free resource indicated by the idle indication information corresponding to each terminal device, to avoid performing blind detection on all grant-free resources. This can reduce a quantity of blind detection times and reduce complexity of blind detection, so as to reduce a workload of blind detection, thereby reducing resource overheads and improving decoding efficiency.

In addition, a probability that the terminal device sends data on a resource that conflicts with that of another terminal device may be further reduced to reduce interference between different terminal devices, thereby increasing a decoding success rate and reliability of the network device.

In a solution, the idle indication information may be carried in one or more of the following: control signaling, a control channel, or a data channel, that is, the idle indication information may be transmitted in an explicit manner.

In another solution, the idle indication information may be associated with one or more of the following: a time domain resource, a frequency domain resource, a space domain resource, a beam domain resource, a code domain resource, a sequence resource, or a power domain resource, that is, the idle indication information may be transmitted in an implicit manner. In this way, when the idle indication information is sent, an additional time-frequency resource may be avoided from being occupied, and the idle indication information is implicitly indicated, so as to reduce resource overheads, thereby further improving efficiency.

It should be noted that the idle indication information may be further transmitted by combining an explicit manner and an implicit manner. For example, one part of the idle indication information may be transmitted in an explicit manner, and the other part of the idle indication information may be transmitted in an implicit manner. In this way, flexibility may be improved.

According to a fourth aspect, a communication method is provided. The communication method includes: A network device sends idle indication information, where the idle indication information indicates an available grant-free resource; and the network device receives data on the grant-free resource indicated by the idle indication information.

In a solution, the idle indication information may be carried in one or more of the following: control signaling, a control channel, or a data channel, that is, the idle indication information may be transmitted in an explicit manner.

In another solution, the idle indication information may be associated with one or more of the following: a time domain resource, a frequency domain resource, a space domain resource, a beam domain resource, a code domain resource, a sequence resource, or a power domain resource, that is, the idle indication information may be transmitted in an implicit manner.

It should be noted that the idle indication information may be further transmitted by combining an explicit manner and an implicit manner. For example, one part of the idle indication information may be transmitted in an explicit manner, and the other part of the idle indication information may be transmitted in an implicit manner.

In addition, for technical effects of the communication method according to the fourth aspect, refer to the technical effects of the communication method according to the third aspect. Details are not described herein again.

According to a fifth aspect, a communication apparatus is provided. The communication apparatus includes a processing module and a transceiver module. The processing module is configured to control the transceiver module to send resource reservation information, where the resource reservation information is used to reserve a grant-free resource. The processing module is configured to control the transceiver module to send data on an actually reserved grant-free resource.

In a solution, the resource reservation information is carried in one or more of the following: control signaling, a control channel, or a data channel, that is, the resource reservation information may be transmitted in an explicit manner.

In another solution, the resource reservation information is associated with one or more of the following: a time domain resource, a frequency domain resource, a space domain resource, a beam domain resource, a code domain resource, a sequence resource, or a power domain resource, that is, the resource reservation information may also be transmitted in an implicit manner.

It should be noted that the resource reservation information may be further transmitted by combining an explicit manner and an implicit manner. For example, one part of the resource reservation information may be transmitted in an explicit manner, and the other part of the resource reservation information may be transmitted in an implicit manner.

In a solution, the resource reservation information is used to reserve a first resource in the grant-free resource. The processing module is configured to control the transceiver module to receive reservation result information, where the reservation result information indicates that the first resource is successfully reserved. The processing module is configured to control the transceiver module to send the data on the first resource.

In another solution, the resource reservation information is used to reserve a first resource in the grant-free resource. The processing module is configured to control the transceiver module to receive reservation result information, where the reservation result information includes reservation failure indication information of the first resource and availability indication information, the availability indication information indicates a second resource, and the second resource is an available grant-free resource, that is, an idle resource in the grant-free resource. The processing module is configured to control the transceiver module to send the data on the second resource.

In still another solution, the resource reservation information is used to reserve a first resource in the grant-free resource. The processing module is configured to control the transceiver module to receive reservation result information, where the reservation result information includes reservation failure indication information of the first resource. The processing module is configured to control the transceiver module to send the data on a third resource, where the third resource is a resource in the grant-free resource other than the first resource.

Optionally, the reservation result information may be carried in one or more of the following: control signaling, a control channel, or a data channel, that is, the reservation result information may also be transmitted in an explicit manner.

Alternatively, the reservation result information may be associated with one or more of the following: a time domain resource, a frequency domain resource, a space domain resource, a beam domain resource, a code domain resource, a sequence resource, or a power domain resource, that is, the reservation result information may also be transmitted in an implicit manner.

It should be noted that the reservation result information may be further transmitted by combining an explicit manner and an implicit manner. For example, one part of the reservation result information may be transmitted in an explicit manner, and the other part of the reservation result information may be transmitted in an implicit manner.

In a solution, the resource reservation information is used to reserve a first resource in the grant-free resource. The processing module is further configured to control the transceiver module to send first reservation cancellation information, where the first reservation cancellation information indicates a resource, whose reservation is canceled, in the first resource. The processing module is further configured to control the transceiver module to send the data on a fourth resource, where the fourth resource is a resource in the grant-free resource other than the resource whose reservation is canceled.

Optionally, the first reservation cancellation information may be carried in one or more of the following: control signaling, a control channel, or a data channel, that is, the first reservation cancellation information may be transmitted in an explicit manner.

Alternatively, the first reservation cancellation information may be associated with one or more of the following: a time domain resource, a frequency domain resource, a space domain resource, a beam domain resource, a code domain resource, a sequence resource, or a power domain resource, that is, the first reservation cancellation information may also be transmitted in an implicit manner.

It should be noted that the first reservation cancellation information may be further transmitted by combining an explicit manner and an implicit manner. For example, one part of the first reservation cancellation information may be transmitted in an explicit manner, and the other part of the first reservation cancellation information may be transmitted in an implicit manner.

In a solution, the resource reservation information is used to reserve a first resource in the grant-free resource. The processing module is further configured to control the transceiver module to receive second reservation cancellation information, where the second reservation cancellation information indicates a resource, whose reservation is canceled, in the first resource. The processing module is further configured to control the transceiver module to send the data on a fifth resource, where the fifth resource is a resource in a provided resource other than the resource whose reservation is canceled.

Optionally, the second reservation cancellation information may be carried in one or more of the following: control signaling, a control channel, or a data channel, that is, the second reservation cancellation information may be transmitted in an explicit manner.

Alternatively, the second reservation cancellation information may be associated with one or more of the following: a time domain resource, a frequency domain resource, a space domain resource, a beam domain resource, a code domain resource, a sequence resource, or a power domain resource, that is, the second reservation cancellation information may also be transmitted in an implicit manner.

It should be noted that the second reservation cancellation information may be further transmitted by combining an explicit manner and an implicit manner. For example, one part of the second reservation cancellation information may be transmitted in an explicit manner, and the other part of the second reservation cancellation information may be transmitted in an implicit manner.

In a solution, the actually reserved grant-free resource is related to a status of a resource in the grant-free resource.

Optionally, the transceiver module may include a receiving module and a sending module. The transceiver module is configured to implement a sending function and a receiving function of the communication apparatus according to the fifth aspect.

Optionally, the communication apparatus according to the fifth aspect may further include a storage module, and the storage module stores a program or instructions. When the processing module executes the program or the instructions, the communication apparatus is enabled to perform the communication method according to the first aspect.

It should be noted that, the communication apparatus according to the fifth aspect may be a terminal device, may be a chip (system) or another part or component that can be disposed in a terminal device, or may be an apparatus including a terminal device. This is not limited in this disclosure.

In addition, for technical effects of the communication apparatus according to the fifth aspect, refer to the technical effects of the communication method according to the first aspect. Details are not described herein again.

According to a sixth aspect, a communication apparatus is provided. The communication apparatus includes a processing module and a transceiver module. The processing module is configured to control the transceiver module to receive resource reservation information, where the resource reservation information is used to reserve a grant-free resource. The processing module is configured to control the transceiver module to receive data on an actually reserved grant-free resource.

In a solution, the resource reservation information is carried in one or more of the following: control signaling, a control channel, or a data channel, that is, the resource reservation information may be transmitted in an explicit manner.

In another solution, the resource reservation information is associated with one or more of the following: a time domain resource, a frequency domain resource, a space domain resource, a beam domain resource, a code domain resource, a sequence resource, or a power domain resource, that is, the resource reservation information may also be transmitted in an implicit manner.

It should be noted that the resource reservation information may be further transmitted by combining an explicit manner and an implicit manner. For example, one part of the resource reservation information may be transmitted in an explicit manner, and the other part of the resource reservation information may be transmitted in an implicit manner.

In a solution, the resource reservation information is used to reserve a first resource in the grant-free resource. The processing module is configured to control the transceiver module to send reservation result information, where the reservation result information indicates that the first resource is successfully reserved. The processing module is configured to control the transceiver module to receive the data on the first resource.

In another solution, the resource reservation information is used to reserve a first resource in the grant-free resource. The processing module is configured to control the transceiver module to send reservation result information, where the reservation result information includes reservation failure indication information of the first resource and availability indication information, the availability indication information indicates a second resource, and the second resource is an available grant-free resource. The processing module is configured to control the transceiver module to receive the data on the second resource.

In still another solution, the resource reservation information is used to reserve a first resource in the grant-free resource. The processing module is configured to control the transceiver module to send reservation result information, where the reservation result information includes reservation failure indication information of the first resource. The processing module is configured to control the transceiver module to receive the data on a third resource, where the third resource is a resource in the grant-free resource other than the first resource.

Optionally, the reservation result information may be carried in one or more of the following: control signaling, a control channel, or a data channel, that is, the reservation result information may be transmitted in an explicit manner.

Alternatively, the reservation result information may be associated with one or more of the following: a time domain resource, a frequency domain resource, a space domain resource, a beam domain resource, a code domain resource, a sequence resource, or a power domain resource, that is, the reservation result information may also be transmitted in an implicit manner.

It should be noted that the reservation result information may be further transmitted by combining an explicit manner and an implicit manner. For example, one part of the reservation result information may be transmitted in an explicit manner, and the other part of the reservation result information may be transmitted in an implicit manner.

In a solution, the resource reservation information is used to reserve a first resource in the grant-free resource. The processing module is further configured to control the transceiver module to receive first reservation cancellation information, where the first reservation cancellation information indicates a resource, whose reservation is canceled, in the first resource. The processing module is further configured to control the transceiver module to receive the data on a fourth resource, where the fourth resource is a resource in the grant-free resource other than the resource whose reservation is canceled.

Optionally, the first reservation cancellation information may be carried in one or more of the following: control signaling, a control channel, or a data channel, that is, the first reservation cancellation information may be transmitted in an explicit manner.

Alternatively, the first reservation cancellation information may be associated with one or more of the following: a time domain resource, a frequency domain resource, a space domain resource, a beam domain resource, a code domain resource, a sequence resource, or a power domain resource, that is, the first reservation cancellation information may also be transmitted in an implicit manner.

It should be noted that the first reservation cancellation information may be further transmitted by combining an explicit manner and an implicit manner. For example, one part of the first reservation cancellation information may be transmitted in an explicit manner, and the other part of the first reservation cancellation information may be transmitted in an implicit manner.

In a solution, the resource reservation information is used to reserve a first resource in the grant-free resource. The processing module is further configured to control the transceiver module to send second reservation cancellation information, where the second reservation cancellation information indicates a resource, whose reservation is canceled, in the first resource. The processing module is further configured to control the transceiver module to receive the data on a fifth resource, where the fifth resource is a resource in a provided resource other than the resource whose reservation is canceled.

Optionally, the second reservation cancellation information may be carried in one or more of the following: control signaling, a control channel, or a data channel, that is, the second reservation cancellation information may be transmitted in an explicit manner.

Alternatively, the second reservation cancellation information may be associated with one or more of the following: a time domain resource, a frequency domain resource, a space domain resource, a beam domain resource, a code domain resource, a sequence resource, or a power domain resource, that is, the second reservation cancellation information may also be transmitted in an implicit manner.

It should be noted that the second reservation cancellation information may be further transmitted by combining an explicit manner and an implicit manner. For example, one part of the second reservation cancellation information may be transmitted in an explicit manner, and the other part of the second reservation cancellation information may be transmitted in an implicit manner.

In a solution, the actually reserved grant-free resource is related to a status of a resource in the grant-free resource.

Optionally, the transceiver module may include a receiving module and a sending module. The transceiver module is configured to implement a sending function and a receiving function of the communication apparatus according to the sixth aspect.

Optionally, the communication apparatus according to the sixth aspect may further include a storage module, and the storage module stores a program or instructions. When the processing module executes the program or the instructions, the communication apparatus is enabled to perform the communication method according to the second aspect.

It should be noted that, the communication apparatus according to the sixth aspect may be a network device, may be a chip (system) or another part or component that can be disposed in a network device, or may be an apparatus including a network device. This is not limited in this disclosure.

In addition, for technical effects of the communication apparatus according to the sixth aspect, refer to the technical effects of the communication method according to the second aspect. Details are not described herein again.

According to a seventh aspect, a communication apparatus is provided. The communication apparatus includes a receiving module and a sending module. The receiving module is configured to receive idle indication information, where the idle indication information indicates an available grant-free resource. The sending module is configured to send data on the grant-free resource indicated by the idle indication information.

In a n solution, the idle indication information is carried in one or more of the following: control signaling, a control channel, or a data channel, that is, the idle indication information may be transmitted in an explicit manner.

In another solution, the idle indication information is associated with one or more of the following: a time domain resource, a frequency domain resource, a space domain resource, a beam domain resource, a code domain resource, a sequence resource, or a power domain resource, that is, the idle indication information may be transmitted in an implicit manner.

It should be noted that the idle indication information may be further transmitted by combining an explicit manner and an implicit manner. For example, one part of the idle indication information may be transmitted in an explicit manner, and the other part of the idle indication information may be transmitted in an implicit manner.

Optionally, the sending module and the receiving module may be integrated into one module, for example, a transceiver module. The transceiver module is configured to implement a sending function and a receiving function of the communication apparatus.

Optionally, the communication apparatus according to the seventh aspect may further include a processing module. The processing module is configured to implement a processing function of the communication apparatus.

Optionally, the communication apparatus according to the seventh aspect may further include a storage module, and the storage module stores a program or instructions. When the processing module executes the program or the instructions, the communication apparatus is enabled to perform the communication method according to the third aspect.

It should be noted that, the communication apparatus according to the seventh aspect may be a terminal device, may be a chip (system) or another part or component that can be disposed in a terminal device, or may be an apparatus including a terminal device. This is not limited in this disclosure.

In addition, for technical effects of the communication apparatus according to the seventh aspect, refer to the technical effects of the communication method according to the third aspect. Details are not described herein again.

According to an eighth aspect, a communication apparatus is provided. The communication apparatus includes a receiving module and a sending module. The sending module is configured to send idle indication information, where the idle indication information indicates an available grant-free resource. The receiving module is configured to receive data on the grant-free resource indicated by the idle indication information.

In a solution, the idle indication information is carried in one or more of the following: control signaling, a control channel, or a data channel, that is, the idle indication information may be transmitted in an explicit manner.

In another solution, the idle indication information is associated with one or more of the following: a time domain resource, a frequency domain resource, a space domain resource, a beam domain resource, a code domain resource, a sequence resource, or a power domain resource, that is, the idle indication information may be transmitted in an implicit manner.

It should be noted that the idle indication information may be further transmitted by combining an explicit manner and an implicit manner. For example, one part of the idle indication information may be transmitted in an explicit manner, and the other part of the idle indication information may be transmitted in an implicit manner.

Optionally, the sending module and the receiving module may be integrated into one module, for example, a transceiver module. The transceiver module is configured to implement a sending function and a receiving function of the communication apparatus.

Optionally, the communication apparatus according to the eighth aspect may further include a processing module. The processing module is configured to implement a processing function of the communication apparatus.

Optionally, the communication apparatus according to the eighth aspect may further include a storage module, and the storage module stores a program or instructions. When the processing module executes the program or the instructions, the communication apparatus is enabled to perform the communication method according to the fourth aspect.

It should be noted that, the communication apparatus according to the eighth aspect may be a network device, may be a chip (system) or another part or component that can be disposed in a network device, or may be an apparatus including a network device. This is not limited in this disclosure.

In addition, for technical effects of the communication apparatus according to the eighth aspect, refer to the technical effects of the communication method according to the fourth aspect. Details are not described herein again.

According to a ninth aspect, a communication apparatus is provided. The communication apparatus is configured to perform the communication method according to any one of the implementations of the first aspect to the fourth aspect.

In this disclosure, the communication apparatus according to the ninth aspect may be the terminal device according to any one of the first aspect or the third aspect, the network device according to any one of the second aspect or the fourth aspect, a chip (system) or another part or component that can be disposed in the terminal device or the network device, or an apparatus including the terminal device or the network device.

It should be understood that the communication apparatus according to the ninth aspect includes a corresponding module, unit, or means for implementing the communication method according to any one of the first aspect to the fourth aspect. The module, the unit, or the means may be implemented by hardware, may be implemented by software, or may be implemented by hardware by executing corresponding software. The hardware or the software includes one or more modules or units configured to perform functions related to the foregoing communication methods.

According to a tenth aspect, a communication apparatus is provided. The communication apparatus includes a processor, and the processor is configured to perform the communication method according to any one of the implementations of the first aspect to the fourth aspect.

In a solution, the communication apparatus according to the tenth aspect may further include a transceiver. The transceiver may be a transceiver circuit or an interface circuit. The transceiver may be used by the communication apparatus according to the tenth aspect to communicate with another communication apparatus.

In a solution, the communication apparatus according to the tenth aspect may further include a memory. The memory and the processor may be integrated together, or may be disposed separately. The memory may be configured to store a computer program and/or data related to the communication method according to any one of the first aspect to the fourth aspect.

In this disclosure, the communication apparatus according to the tenth aspect may be the terminal device in the first aspect or the third aspect, the network device in the second aspect or the fourth aspect, a chip (system) or another part or component that can be disposed in the terminal device or the network device, or an apparatus including the terminal device or the network device.

According to an eleventh aspect, a communication apparatus is provided. The communication apparatus includes a processor. The processor is coupled to a memory, and the processor is configured to execute a computer program stored in the memory, so that the communication apparatus performs the communication method according to any one of the implementations of the first aspect to the fourth aspect.

In a solution, the communication apparatus according to the eleventh aspect may further include a transceiver. The transceiver may be a transceiver circuit or an interface circuit. The transceiver may be used by the communication apparatus according to the eleventh aspect to communicate with another communication apparatus.

In this disclosure, the communication apparatus according to the eleventh aspect may be the terminal device in the first aspect or the third aspect, the network device in the second aspect or the fourth aspect, a chip (system) or another part or component that can be disposed in the terminal device or the network device, or an apparatus including the terminal device or the network device.

According to a twelfth aspect, a communication apparatus is provided, including a processor and a memory. The memory is configured to store a computer program, and when the processor executes the computer program, the communication apparatus performs the communication method according to any one of the implementations of the first aspect to the fourth aspect.

In a solution, the communication apparatus according to the twelfth aspect may further include a transceiver. The transceiver may be a transceiver circuit or an interface circuit. The transceiver may be used by the communication apparatus according to the twelfth aspect to communicate with another communication apparatus.

In this disclosure, the communication apparatus according to the twelfth aspect may be the terminal device in the first aspect or the third aspect, the network device in the second aspect or the fourth aspect, a chip (system) or another part or component that can be disposed in the terminal device or the network device, or an apparatus including the terminal device or the network device.

According to a thirteenth aspect, a communication apparatus is provided, including a processor. The processor is configured to: be coupled to a memory; and after reading a computer program in the memory, perform, based on the computer program, the communication method according to any one of the implementations of the first aspect to the fourth aspect.

In a solution, the communication apparatus according to the thirteenth aspect may further include a transceiver. The transceiver may be a transceiver circuit or an interface circuit. The transceiver may be used by the communication apparatus according to the thirteenth aspect to communicate with another communication apparatus.

In this disclosure, the communication apparatus according to the thirteenth aspect may be the terminal device in the first aspect or the third aspect, the network device in the second aspect or the fourth aspect, a chip (system) or another part or component that can be disposed in the terminal device or the network device, or an apparatus including the terminal device or the network device.

In addition, for technical effects of the communication apparatuses according to the ninth aspect to the thirteenth aspect, refer to the technical effects of the communication method according to any one of the implementations of the first aspect to the fourth aspect. Details are not described herein again.

According to a fourteenth aspect, a processor is provided. The processor is configured to perform the communication method according to any one of the implementations of the first aspect to the fourth aspect.

According to a fifteenth aspect, a communication system is provided. The communication system includes one or more terminal devices and one or more network devices.

According to a sixteenth aspect, a computer-readable storage medium is provided, including a computer program or instructions. When the computer program or the instructions are run on a computer, the computer is enabled to perform the communication method according to any one of the implementations of the first aspect to the fourth aspect.

According to a seventeenth aspect, a computer program product is provided, including a computer program or instructions. When the computer program or the instructions are run on a computer, the computer is enabled to perform the communication method according to any one of the implementations of the first aspect to the fourth aspect.

### BRIEF DESCRIPTION OF DRAWINGS

FIG. 1 is a flowchart of dynamic grant-based transmission according to an embodiment of this disclosure;

FIG. 2 is a flowchart of a 2-step random access process according to an embodiment of this disclosure;

FIG. 3 is a flowchart of a 4-step random access process according to an embodiment of this disclosure;

FIG. 4 is a first diagram of an architecture of a communication system according to an embodiment of this disclosure;

FIG. 5 is a second diagram of an architecture of a communication system according to an embodiment of this disclosure;

FIG. 6 is a diagram of a signal flow direction in a communication method according to an embodiment of this disclosure;

FIG. 7 is a first flowchart of a communication method according to an embodiment of this disclosure;

FIG. 8 is a diagram of a resource indicated by resource reservation information according to an embodiment of this disclosure;

FIG. 9 is a diagram of a first resource according to an embodiment of this disclosure;

FIG. 10 is a diagram of an available resource indicated by reservation result information according to an embodiment of this disclosure;

FIG. 11 is a first diagram of a second resource according to an embodiment of this disclosure;

FIG. 12 is a second diagram of a second resource according to an embodiment of this disclosure;

FIG. 13 is a third diagram of a second resource according to an embodiment of this disclosure;

FIG. 14 is a fourth diagram of a second resource according to an embodiment of this disclosure;

FIG. 15 is a diagram of a third resource according to an embodiment of this disclosure;

FIG. 16 is a diagram of a relationship between an unavailable resource and a first resource according to an embodiment of this disclosure;

FIG. 17 is a diagram of a resource indicated by reservation result information according to an embodiment of this disclosure;

FIG. 18 is a diagram of a fourth resource according to an embodiment of this disclosure;

FIG. 19 is a second flowchart of a communication method according to an embodiment of this disclosure;

FIG. 20 is a diagram of a correspondence between a beam domain resource and a terminal device according to an embodiment of this disclosure;

FIG. 21 is a first diagram of a structure of a communication apparatus according to an embodiment of this disclosure;

FIG. 22 is a second diagram of a structure of a communication apparatus according to an embodiment of this disclosure; and

FIG. 23 is a third diagram of a structure of a communication apparatus according to an embodiment of this disclosure.

### DESCRIPTION OF EMBODIMENTS

For ease of understanding, the following first describes technical terms related to embodiments of this disclosure.

Dynamic grant-based (GB) transmission, which may also be referred to as dynamic grant-based uplink transmission, is a technology in which a terminal device dynamically grants, dynamically schedules, or dynamically configures a resource based on downlink control information (DCI) delivered by a network device, and performs uplink transmission based on the dynamically granted resource, the dynamically scheduled resource, or the dynamically configured resource.

Grant-free transmission, namely, dynamic grant-free (GF) transmission, is a technology in which a terminal device performs uplink transmission without requiring a network device to deliver DCI to dynamically grant, dynamically schedule, or dynamically configure a resource. Grant-free transmission includes one or more of the following: random access (RA)-based transmission, configuration-based grant (CG) resource-based transmission in a 5th generation (5G) new radio system, preconfigured uplink resource (PUR)-based transmission in a long term evolution (LTE) system, semi-persistent scheduling-based transmission in an LTE system, semi-persistent channel state information (SP-CSI)-based transmission, and small data packet transmission (SDT), or another technology for transmitting data in a dynamic grant-free manner. RA includes 2-step random access (2-step RA) and 4-step random access (4-step RA).

When performing grant-free transmission, a terminal device may transmit one or more of the following: a data channel (such as a PUSCH), a control channel (such as a physical uplink control channel (PUCCH)), a physical random access channel (PRACH), or a physical-layer signal (such as a reference signal). A channel or a signal transmitted in grant-free transmission is related to a scenario of grant-free transmission or a technology used in grant-free transmission. For example, a PRACH and/or a PUSCH may be transmitted in grant-free transmission that is based on 2-step random access. For another example, a PUSCH may be transmitted in PUR-based, SPS-based, or CG-based grant-free transmission.

A grant-free resource is a resource that is agreed on in a protocol or that is configured by a network device for a terminal device and that is used for grant-free transmission. For example, the grant-free resource may include one or more of the following resources: a time domain resource, a frequency domain resource, a space domain resource, a beam domain resource, a code domain resource, a sequence resource, or a power domain resource. The code domain resource may include a non-orthogonal multiple access signature. The sequence resource (also referred to as a pilot resource) may include one or more of the following: a demodulation reference signal (DMRS) sequence, a preamble sequence, or a sequence used by another reference signal (RS).

For example, the grant-free resource may be configured in one or more of the following manners: radio resource control (RRC) signaling, a media access control control element (MAC CE), or DCI. A manner of configuring the grant-free resource by using the DCI may include a semi-static configuration manner or a static configuration manner. In addition, when the grant-free resource is agreed on in a protocol or is configured by a network device, a transmission parameter used for grant-free transmission may be further agreed on or configured. The transmission parameter may include one or more of the following parameters: a periodicity of a time domain resource, a parameter related to open-loop power control, a waveform, a redundancy version sequence, a quantity of repetitions, a frequency hopping mode, a resource allocation type, a quantity of hybrid automatic repeat request (HARQ) processes, a DMRS-related parameter, a modulation and coding scheme table, a resource block group (RBG) size, a time domain resource, a frequency domain resource, or a modulation and coding scheme (MCS). It may be understood that the grant-free resource may be periodic.

To facilitate understanding of the communication method provided in embodiments of this disclosure, the following describes a background technology related to this disclosure.

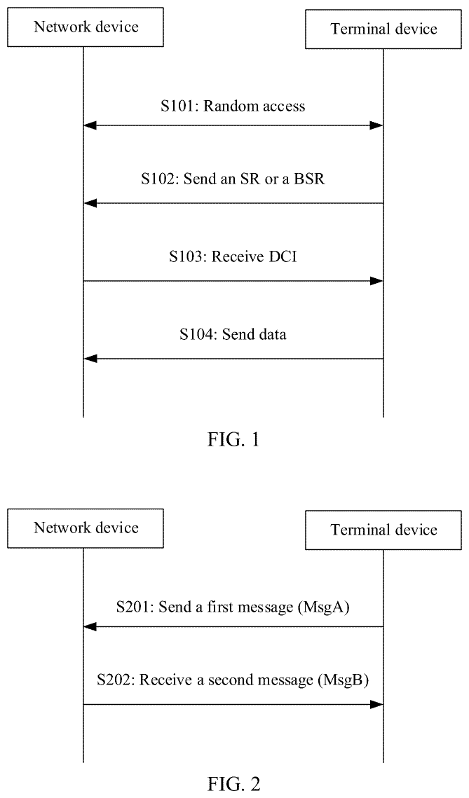

FIG. 1 is a flowchart of dynamic grant-based transmission. As shown in FIG. 1, in a cellular network communication system such as an LTE system or a 5G NR system, if a terminal device in an idle state (e.g. idle state or idle mode) or an inactive state (e.g. inactive state or inactive mode) needs to send user plane (UP) data to a network device, the terminal device needs to perform S101 to S104.

S101: The terminal device performs a random access (RA) operation, and enters an active state (e.g. active state or active mode).

It should be noted that the active state may also be referred to as a connected state (e.g. connected state or connected mode).

S102: The terminal device sends a scheduling request (SR) or a buffer state report (BSR) to the network device.

The SR indicates whether the terminal device has uplink data that needs to be transmitted, and when the terminal device has uplink data that needs to be transmitted, the terminal device requests the network device to allocate an uplink resource to the terminal device. The BSR may indicate a buffer state (BS) of to-be-sent data on the terminal device, that is, a data amount of to-be-sent data in an uplink buffer of the terminal device, to request the network device to allocate an uplink resource to the terminal device. The SR may be carried in a PUCCH. The BSR may be carried in a PUSCH. For example, data is carried in the PUSCH, and the BSR may be carried in media access control (MAC) layer signaling, for example, a MAC CE of a data packet.

S103: The network device sends DCI to the terminal device.

The DCI carries uplink grant (UL Grant) information, and the uplink grant information may indicate a resource and a transmission parameter that are used by the terminal device to transmit data.

For example, the DCI may be carried in a physical downlink control channel (PDCCH). The network device sends, to the terminal device, the PDCCH carrying the DCI. The terminal device in a connected state may listen to the PDCCH delivered by the network device, to obtain the DCI.

S104: The terminal device sends data to the network device.

The terminal device sends, based on the uplink grant information carried in the DCI, data to the network device on a resource indicated by the uplink grant information.

In the GB transmission solution shown in FIG. 1, a resource and a transmission parameter that are used to transmit data can be flexibly configured. However, in the GB transmission solution, the network device needs to deliver a PDCCH for each data packet of each terminal device. If there are a large quantity of terminal devices or the terminal device frequently sends data, PDCCH overheads are large, and time-frequency resources used to send the PDCCH are insufficient. Consequently, the PDCCH is blocked, and system performance is reduced. In addition, the terminal device needs to listen to the PDCCH before sending data each time, causing large power consumption and a high delay of the terminal device.

To overcome the foregoing disadvantages of GB transmission, in some solutions, a GF technology may be used to transmit data. In the GF technology, data is transmitted based on a configured grant-free resource, so as to prevent configuring a corresponding PDCCH for each data packet of the terminal device.

For example, when the terminal device has a data sending requirement, if the terminal device is in an inactive state (e.g. inactive state or inactive mode) or an idle state (e.g. idle state or idle mode), the terminal device may complete uplink data transmission in an RA process, for example, a 2-step random access process or a 4-step random access process. The following separately uses examples for description with reference to the 2-step random access process and the 4-step random access process.

FIG. 2 is a flowchart of a 2-step random access process according to an embodiment of this disclosure. As shown in FIG. 2, 2-step random access includes S201 and S202.

S201: A terminal device sends a first message (for example, MsgA) to a network device.

The first message includes a PRACH and a PUSCH. The PRACH is used to carry a random access preamble, and the PUSCH is used to carry control plane (CP) data and/or user plane (UP) data. The network device may estimate a timing advance (TA) of the terminal device based on the random access preamble.

S202: The network device sends a second message (for example, MsgB) to the terminal device.

For example, after receiving the first message, the network device sends the second message to the terminal device.

If the network device correctly obtains the PUSCH in the first message through decoding, the second message is also referred to as a success random access response (RAR). In this case, the second message includes a contention resolution message. If the network device does not correctly obtain the PUSCH through decoding, the second message is also referred to as a fallback random access response (fallback RAR). After receiving the fallback random access response, the terminal device falls back to a procedure in a 4-step random access process based on uplink grant (UL grant) information carried in the fallback random access response.

In the foregoing 2-step random access process, the terminal device may add data to the PRACH and the PUSCH that correspond to the first message, to implement grant-free transmission of the data.

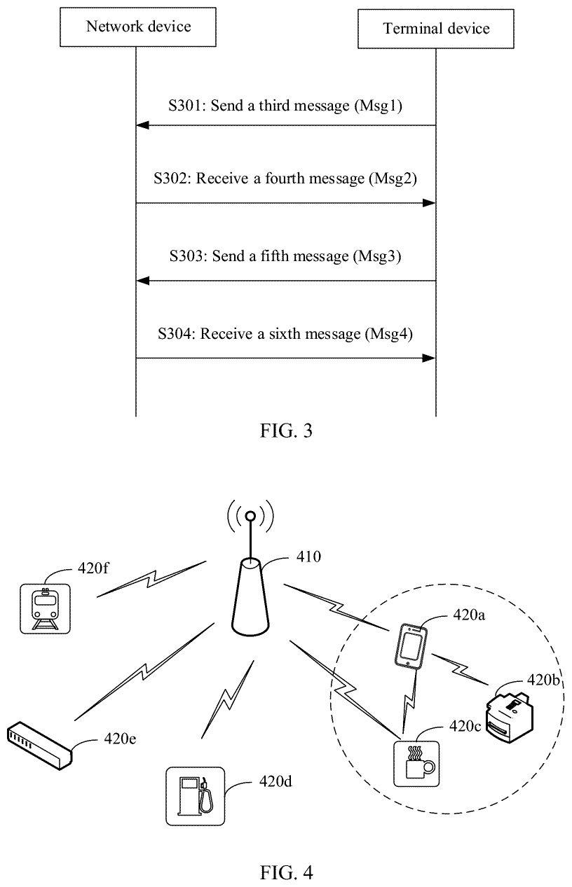

FIG. 3 is a flowchart of a 4-step random access process according to an embodiment of this disclosure. As shown in FIG. 3, the 4-step random access process includes S301 to S304.

S301: A terminal device sends a third message (Msg1) to a network device.

The third message includes a random access preamble.

S302: The network device sends a fourth message (Msg2) to the terminal device.

The fourth message includes a random access response.

S303: The terminal device sends a fifth message (Msg3) to the network device.

The fifth message includes an identifier or data of the terminal device.

S304: The network device sends a sixth message (Msg4) to the terminal device.

The sixth message includes a contention resolution message.

In the foregoing 4-step random access process, the terminal device may add data to a PRACH that carries the third message (Msg1), to implement grant-free transmission of the data.

For another example, in some scenarios, for example, the terminal device has obtained an accurate timing advance, or a cell radius is relatively small and the terminal device does not need to re-obtain a TA, the terminal device may not send a PRACH, but send a PUSCH by using a grant-free resource, to implement data transmission (this solution is referred to as direct data transmission for short below). Direct data transmission includes SPS-based transmission and PUR-based transmission in an LTE system, and CG resource-based transmission in a 5G NR system. In this way, sending a preamble may be avoided, thereby reducing overheads and reducing power consumption.

However, in the foregoing grant-free transmission solution, a grant-free resource used to transmit data is randomly selected by the terminal device. In this way, when the network device performs blind detection, accuracy of blind detection is low, and complexity is high. Consequently, problems of high resource overheads and low decoding efficiency are caused.

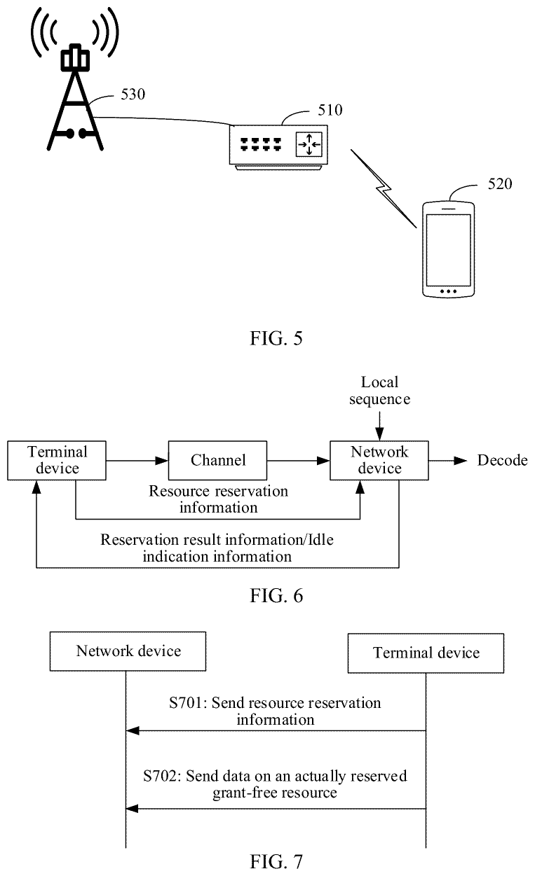

To resolve the foregoing technical problem in grant-free transmission, embodiments of this disclosure provide a communication method. The communication method may be applied to the following communication system shown in FIG. 4 or FIG. 5.

The following describes technical solutions in this disclosure with reference to the accompanying drawings.

The technical solutions in embodiments of this disclosure may be applied to various communication systems, for example, a wireless fidelity (Wi-Fi) system, a vehicle-to-everything (V2X) communication system, a device-to-device (D2D) communication system, an Internet of Vehicles communication system, a 4th generation (4G) mobile communication system such as a long term evolution (LTE) system and a worldwide interoperability for microwave access (WiMAX) communication system, a 5th generation (5G) mobile communication system such as a new radio (NR) system, and a future communication system such as a 6th generation (6G) mobile communication system.

All aspects, embodiments, or features are presented in this disclosure by describing a system that may include a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

In addition, in embodiments of this disclosure, words such as “example” and “for example” are used to represent giving an example, an illustration, or a description. Any embodiment or design solution described as an “example” in this disclosure should not be explained as being more preferred or having more advantages than another embodiment or design solution. The use of the word “example” is intended to present a concept in a specific manner.

In embodiments of this disclosure, terms “information”, “signal”, “message”, “channel”, and “signaling” may be interchangeably used sometimes. It should be noted that meanings expressed by the terms are consistent when differences of the terms are not emphasized. Terms “of”, “corresponding (corresponding, relevant)”, and corresponding may be interchangeably used sometimes. It should be noted that meanings expressed by the terms are consistent when differences of the terms are not emphasized.

In embodiments of this disclosure, a subscript such as W₁ may sometimes be written in a non-subscript form such as W1 due to a clerical error. Meanings expressed by the forms are consistent when differences of the forms are not emphasized.

The network architecture and the service scenario described in embodiments of this disclosure are intended to describe the technical solutions in embodiments of this disclosure more clearly, and do not constitute a limitation on the technical solutions provided in embodiments of this disclosure. A person of ordinary skill in the art may know that, with evolution of the network architecture and emergence of new service scenarios, the technical solutions provided in embodiments of this disclosure are also applicable to similar technical problems.

For ease of understanding of embodiments of this disclosure, a communication system applicable to embodiments of this disclosure is described below in detail with reference to the communication systems shown in FIG. 4 and FIG. 5 as examples. For example, FIG. 4 is a first diagram of an architecture of a communication system to which a communication method is applicable according to an embodiment of this disclosure.

As shown in FIG. 4, the communication system includes a network device (e.g. 410 in FIG. 4) and a terminal device (e.g. 420a to 420f in FIG. 4).

The network device is a device that is located on a network side of the communication system and that has a wireless receiving/sending function, or a chip or a chip system that can be disposed in the device. The network device includes but is not limited to: an access point (AP), for example, a home gateway, a router, a server, a switch, or a bridge, in a wireless fidelity (Wi-Fi) system, an evolved NodeB (eNB), a radio network controller (RNC), a NodeB (NB), a base station controller (BSC), a base transceiver station (BTS), a home base station (for example, a home evolved NodeB, or a home NodeB, HNB), a baseband unit (BBU), a relay node, a wireless backhaul node, a transmission and reception point (TRP), or transmission point (TP), and the like. The network device may alternatively be a gNB or a TRP or a TP in a 5G system, for example, a new radio (NR) system, or one antenna panel or a group of antenna panels (including a plurality of antenna panels) of a gNB in a 5G system. The network device may alternatively be a network node, for example, a baseband unit (BBU) or a distributed unit (DU), that constitutes a gNB or a transmission and reception point, a road side unit (RSU) having a base station function, or the like.

The terminal device is a terminal that accesses the communication system and that has a wireless receiving/sending function, or a chip or a chip system that can be disposed in the terminal. The terminal device may also be referred to as a user equipment, an access terminal, a subscriber unit, a subscriber station, a mobile station, a remote station, a remote terminal, a mobile device, a user terminal, a terminal, a wireless communication device, a user agent, or a user apparatus. The terminal device in embodiments of this disclosure may be a mobile phone, a tablet computer (Pad), a computer with a wireless receiving/sending function, a virtual reality (VR) terminal device, an augmented reality (AR) terminal device, a wireless terminal in industrial control, a wireless terminal in self driving, a wireless terminal in telemedicine or telehealth services, a wireless terminal in a smart grid, a wireless terminal in transportation safety, a wireless terminal in a smart city, a wireless terminal in a smart home, an in-vehicle terminal, an RSU with a terminal function, or the like. The terminal device in this disclosure may alternatively be an in-vehicle module, an in-vehicle assembly, an in-vehicle part, an in-vehicle chip, or an in-vehicle unit that is built in a vehicle as one or more parts or units. The vehicle may implement the communication method in this disclosure by using the in-vehicle module, the in-vehicle assembly, the in-vehicle part, the in-vehicle chip, or the in-vehicle unit that is built in the vehicle.

The network device and the terminal device may be at fixed locations, or may be movable. The network device and the terminal device may be deployed on the land, including indoor, outdoor, handheld, or in-vehicle; may be deployed on a water surface; or may be deployed on a plane, a balloon, and a satellite in the air. Disclosure scenarios of the network device and the terminal device are not limited in embodiments of this disclosure.

It may be understood that roles of the network device and the terminal device may be relative. For example, the terminal device 420a to the terminal device 420c in FIG. 4 may also form a communication system. The terminal device 420a in FIG. 4 may be configured as a network device. For the terminal device 420b that accesses the network device 410 by using the terminal device 420a, the terminal device 420a may also be considered as a network device. However, for the network device 410, 420a is a terminal device. Certainly, the terminal devices 420a and 420b may also communicate with each other by using an interface protocol between network devices. In this case, 420a may also be considered as a network device relative to the terminal device 420b. Therefore, both the network device and the terminal device may be collectively referred to as communication apparatuses. the terminal devices 420a and 420f in FIG. 4 may be referred to as communication apparatuses with a function of a network device, or the terminal devices 420a to 420f in FIG. 4 may be referred to as communication apparatuses with a function of a terminal device.

FIG. 5 is a second diagram of an architecture of a communication system to which a communication method is applicable according to an embodiment of this disclosure. As shown in FIG. 5, the communication system includes a network device 510 and a terminal device 520. The network device 510 may be a single-hop or multi-hop relay node. In this case, the network device 510 may be connected to a base station 530. For example, the relay node may be a small cell, an integrated access and backhaul (IAB) node, a distributed unit (DU), a terminal device, or a transmission and reception point (TRP). It may be understood that, in this embodiment of this disclosure, the base station 530 shown in FIG. 5 may also be integrated into the network device 510.

For the terminal device 520, refer to the terminal device (420a to 420f shown in FIG. 4) shown in FIG. 4. Details are not described herein again.

A frequency band for communication between the network device and the terminal device may be a high frequency band, for example, a millimeter-wave frequency band or a terahertz (THz) frequency band, or may be a low frequency band, for example, a frequency band of 3.5 gigahertz (GHz). A frequency band for communication between the network device and the terminal device may be a licensed frequency band, or may be an unlicensed frequency band. Communication between the network device and the terminal device may be based on an air interface link, may be based on a sidelink, or may be based on a non-terrestrial network (NTN) communication link.

In addition, the terminal device is in a connected state, an active state, a non-connected state, or a non-idle state, and the terminal device may be in a state other than the foregoing three states, for example, UE that is not attached to a network or has not performed downlink synchronization with a network.

It should be noted that, the communication method provided in embodiments of this disclosure is applicable to communication between the terminal device and the network device shown in FIG. 4 or FIG. 5. For an implementation, refer to the following method embodiments. Details are not described herein.

It should be noted that, the solutions in embodiments of this disclosure may be further applied to another communication system, and a corresponding name may also be replaced with a name of a corresponding function in the another communication system.

It should be understood that FIG. 4 and FIG. 5 are merely simplified diagrams illustrated for ease of understanding. The communication system may further include another network device and/or another terminal device, which are not shown in FIG. 4 or FIG. 5.

The following describes, with reference to FIG. 6, a communication method provided in an embodiment of this disclosure.

FIG. 6 is a diagram of a signal flow direction in a communication method according to an embodiment of this disclosure. As shown in FIG. 6, in an embodiment, a terminal device may send resource reservation information to a network device on a channel (for example, a PUSCH or a PUCCH), to reserve a grant-free resource. The terminal device may send data to the network device on the reserved grant-free resource. The network device may decode the data from the terminal device based on a local sequence.

In addition, the network device may further send reservation result information to the terminal device, to indicate that a first resource indicated by the resource reservation information is successfully reserved or fails to be reserved, and indicate an available grant-free resource.

In another embodiment, the network device may send idle indication information to the terminal device on a channel, for example, a physical downlink shared channel (PDSCH) or a PDCCH, to indicate an available resource or an available grant-free resource. If the idle indication information indicates the available resource, the terminal device may determine the available grant-free resource based on the available resource and a configured grant-free resource.

The following describes, with reference to FIG. 7 to FIG. 18, a communication method provided in an embodiment of this disclosure.

For example, FIG. 7 is a first flowchart of a communication method according to an embodiment of this disclosure. The communication method is applicable to communication between the network device and the terminal device shown in FIG. 4 or FIG. 5.

As shown in FIG. 7, the communication method includes the following steps.

S701: A terminal device sends resource reservation information, and a network device receives the resource reservation information.

The resource reservation information is used to reserve a grant-free resource.

For example, in this embodiment of this disclosure, the resource reservation information may indicate one or more grant-free resources, for example, a first resource.

The following uses the first resource as an example to describe a grant-free resource indicated by the resource reservation information.

### Example 1: The Grant-Free Resource is a Time-Frequency Resource

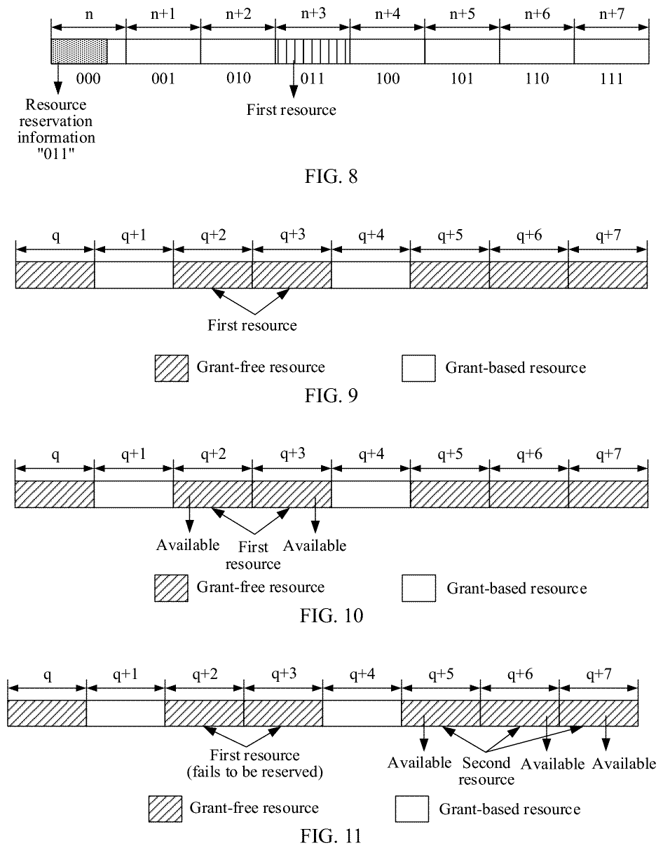

For example, FIG. 8 is a diagram of a grant-free resource indicated by resource reservation information according to an embodiment of this disclosure. As shown in FIG. 8, it is assumed that the grant-free resource is divided into a plurality of first resource periodicities in time domain. One piece of resource reservation information is represented by a combination of three bits, and one combination of three bits corresponds to one of eight first resource periodicities. For example, if the first resource periodicity includes a first resource periodicity n to a first resource periodicity n+7, the first resource periodicity n to the first resource periodicity n+7 sequentially correspond to resource reservation information “000” to resource reservation information “111”, both a start moment and an end moment of the resource reservation information are located in an n^{th} first resource periodicity, and the resource reservation information is “011”, the first resource is a resource in the first resource periodicity n+3.

It may be understood that the first resource periodicity in which the resource reservation information is located may also be any one of the first resource periodicity n to the first resource periodicity n+7. The first resource indicated by the resource reservation information may be a resource in any first resource periodicity after the first resource periodicity in which the resource reservation information is located.

In this embodiment of this disclosure, a plurality of consecutive first resource periodicities, for example, the first resource periodicity n to the first resource periodicity n+7, may form a second resource periodicity. If there are a plurality of second resource periodicities after the first resource periodicity in which the resource reservation information is located, the first resource may be a second resource periodicity after the first resource periodicity in which the resource reservation information is located. For example, the first resource reserved by using the resource reservation information may be a resource in the first resource periodicity n+3 shown in FIG. 8 and/or a resource in a first resource periodicity n+3+8k, where both n and k are positive integers.

Alternatively, as shown in FIG. 8, if the resource reservation information indicates a time domain offset, the first resource is a grant-free resource that is located at a specified start point and that is obtained after the time-domain offset. It may be understood that the specified start point may be a start moment or an end moment of a resource for sending the resource reservation information. For example, the specified start point is a first resource periodicity in which the end moment of the resource for sending the resource reservation information is located, the end moment for sending the resource reservation information is located in the n^{th} first resource periodicity, and the resource reservation information is “011”. In this case, the time domain offset is 2, and the first resource is a resource in the first resource periodicity n+3.

### Example 2: The Grant-Free Resource is a Beam Domain Resource

It is assumed that the network device configures, for a terminal device in a cell, information about a time-frequency resource and information about an associated beam domain resource that are used for grant-free transmission, for example, information about a synchronization signal block (SSB) (the SSB is subsequently used to represent the beam domain resource). One time-frequency resource may be associated with one or more SSBs.

For example, a time-frequency resource 1 is associated with an SSB 1 to an SSB 4, and each SSB is mapped to four preamble sequences. For example, the SSB 1 is mapped to a preamble sequence 1 to a preamble sequence 4, the SSB 2 is mapped to a preamble sequence 5 to a preamble sequence 8, the SSB 3 is mapped to a preamble sequence 9 to a preamble sequence 12, and the SSB 4 is mapped to a preamble sequence 13 to a preamble sequence 16. After the terminal device selects an SSB based on received signal power of the SSB, the terminal device sends, on the time-frequency resource 1, one of preamble sequences mapped to the selected SSB, to implicitly indicate the selected SSB (beam domain resource). For example, if the preamble sequence 13 is sent on the time-frequency resource 1, it indicates that the selected SSB is the SSB4, that is, the first resource is a beam domain resource corresponding to the SSB4.

In a solution, the resource reservation information may be implemented in an explicit manner. For example, the resource reservation information may be carried in one or more of the following: control signaling, a control channel, or a data channel.

For example, the control signaling may be uplink control information (UCI). The UCI may be carried in a PUCCH or a PUSCH. For example, the UCI is a hybrid automatic repeat request-acknowledgement (HARQ-ACK). When the terminal device performs HARQ-ACK feedback on received downlink data (for example, data 1), the HARQ-ACK feedback may carry the resource reservation information. In this case, the resource reservation information may indicate a PUSCH resource (for example, a CG PUSCH resource) for transmitting data 2. In other words, the UCI is carried in the PUSCH.

The control channel may be a PUCCH. In other words, the resource reservation information may be carried in the PUCCH.

The data channel may be a PUSCH. Optionally, the resource reservation information may be carried in a media access control-control element (MAC CE). For example, when sending data 3 to the network device by using the PUSCH, the terminal device adds the grant-free resource reservation information to a MAC CE of the data 3, to reserve a grant-free resource to be used for transmitting a next data packet (data 4). It may be understood that, in this embodiment of this disclosure, the PUSCH used to send the data 3 may be a PUSCH carrying Msg3 or carrying MsgA, or may be a CG PUSCH, a PUR PUSCH, an SPS PUSCH or a dynamically scheduled PUSCH.

Alternatively, the resource reservation information may be used as control plane data, for example, dedicated control channel (DCCH) data, and is mapped to a PUSCH.

In another solution, the resource reservation information may be implemented in an implicit manner. For example, the resource reservation information may be associated with one or more of the following: a time domain resource, a frequency domain resource, a space domain resource, a beam domain resource, a code domain resource, a sequence resource, or a power domain resource.

The code domain resource may include one or more of the following: a spread spectrum sequence, a non-orthogonal multiple access signature, or a sparse mapping sequence. The sequence resource may include one or more of the following: a DMRS sequence, a preamble sequence, or a sequence corresponding to another reference signal.

In this way, when the resource reservation information is sent, an additional time-frequency resource may be avoided from being occupied, and the resource reservation information is implicitly indicated, so as to reduce resource overheads, thereby further improving efficiency.

It may be understood that the resource reservation information may be further transmitted by combining an explicit manner and an implicit manner. For example, one part of the resource reservation information may be transmitted in an explicit manner, and the other part may be transmitted in an implicit manner. In this way, flexibility may be improved. For a manner of implementing the resource reservation information by combining an explicit manner and an implicit manner, refer to the implementations of the explicit indication and the implicit indication. Details are not described herein again.

In addition, in this embodiment of this disclosure, if there is a mapping relationship between a grant-free resource and a HARQ process, the resource reservation information may indicate a reserved HARQ process, to indicate the grant-free resource. For example, if a grant-free resource 1 corresponds to a HARQ process 1, a grant-free resource 2 corresponds to a HARQ process 2, and a HARQ process indicated by the resource reservation information is the HARQ process 2, the grant-free resource indicated by the resource reservation information is the grant-free resource 2.

It should be noted that, the resource reservation information may be sent separately, or may be sent together with other data.

For example, a grant-free resource (which is referred to as an actually reserved grant-free resource for short) actually reserved based on the resource reservation information may include a grant-free resource (which may also be referred to as the first resource) indicated by the resource reservation information, and/or a resource in the grant-free resource other than the first resource.

For ease of understanding, the following describes the actually reserved grant-free resource with reference to a specific case.

In a solution, the network device does not indicate a reservation result of the first resource.

In this case, the first resource indicated by the resource reservation information is the actually reserved grant-free resource.

In this way, the terminal device may send data on the corresponding first resource, and the network device may perform decoding based on the first resource reserved by the terminal device, thereby reducing a decoding workload, reducing overheads, and improving decoding efficiency.

In another solution, the network device indicates a reservation result of the first resource.

In this case, in S701, after the terminal device sends the resource reservation information, and the network device receives the resource reservation information, the communication method shown in FIG. 7 may further include step 1.

Step 1: The network device sends reservation result information, and the terminal device receives the reservation result information.

The reservation result information indicates that the first resource indicated by the resource reservation information is successfully reserved or fails to be reserved. In this case, the actually reserved grant-free resource may be determined based on the resource reservation information together with the reservation result information.

The following further describes the actually reserved grant-free resource with reference to the reservation result information.

Manner 1: The reservation result information indicates whether the first resource is available.

As shown in FIG. 9, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. In this case, the reservation result information may indicate whether the resource q+2 and the resource q+3 are available.

Case 1: The reservation result information may indicate that all first resources are available, that is, the first resource is successfully reserved.

In this case, the actually reserved grant-free resource is the first resource.

As shown in FIG. 10, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the reservation result information indicates that both the resource q+2 and the resource q+3 are available, the first resource is successfully reserved, and actually reserved grant-free resources are the resource q+2 and the resource q+3, that is, the first resource.

In this way, when the first resource is successfully reserved, the terminal device can send data on the first resource, so that a probability that the terminal device sends data on a resource that conflicts with that of another terminal device can be reduced to reduce interference between terminal devices and increase a decoding success rate of the network device, thereby improving reliability and efficiency.

Case 2: The reservation result information includes reservation failure indication information of the first resource, that is, the first resource fails to be reserved.

For example, the reservation failure indication information of the first resource may indicate that there is an unavailable first resource.

In this case, optionally, the reservation result information may further include availability indication information. The availability indication information is used to further indicate a second resource in the grant-free resource, and the second resource is an available grant-free resource. In this case, the actually reserved grant-free resource is one or more resources in the second resource.

For ease of understanding, the following provides descriptions with reference to Case 2-1 to Case 2-3.

Case 2-1: The availability indication information indicates an available grant-free resource, that is, the second resource.

As shown in FIG. 11, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the availability indication information indicates that the resource q+5 to the resource q+7 are all available, the second resource includes the resource q+5 to the resource q+7, and the actually reserved grant-free resource may include one or more of the following resources: the resource q+5, the resource q+6, or the resource q+7.

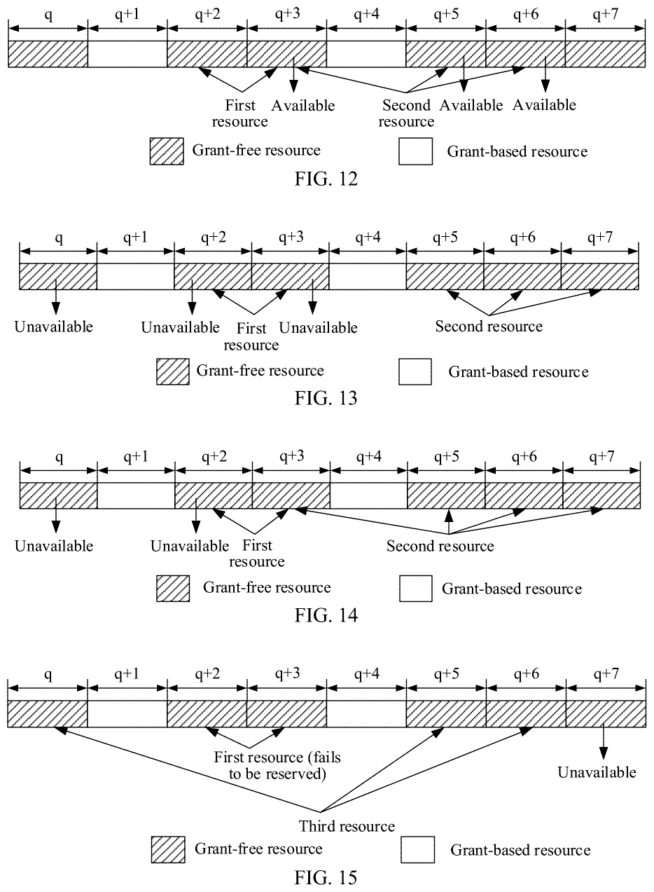

As shown in FIG. 12, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the availability indication information indicates that the resource q+3, the resource q+5, and the resource q+6 are available, the second resource includes the resource q+3, the resource q+5, and the resource q+6, and the actually reserved grant-free resource may include one or more of the following resources: the resource q+3, the resource q+5, or the resource q+6.

Case 2-2: The availability indication information indicates an unavailable grant-free resource to indicate the second resource. The second resource is a resource, in the grant-free resource, other than a grant-free resource that is indicated by the availability indication information as unavailable.

As shown in FIG. 13, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the availability indication information indicates that the resource q is unavailable and the resource q+2 and the resource q+3 are unavailable (that is, the first resource is unavailable), the second resource may include the resource q+5 to the resource q+7, and the actually reserved grant-free resource may include one or more of the following resources: the resource q+5, the resource q+6, or the resource q+7.

As shown in FIG. 14, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the availability indication information indicates that the resource q is unavailable and the resource q+2 is unavailable (that is, the first resource is partially unavailable), the second resource may include the resource q+3 and the resource q+5 to the resource q+7, and the actually reserved grant-free resource may include one or more of the following resources: the resource q+3, the resource q+5, the resource q+6, or the resource q+7.

It may be understood that, in this embodiment of this disclosure, when the first resource fails to be reserved, the availability indication information may indicate both an available grant-free resource and an unavailable grant-free resource. In this case, the second resource may be an available grant-free resource indicated by the availability indication information, and the actually reserved grant-free resource may be a resource in the second resource.

In this way, the terminal device may receive the reservation result information, and send data on the second resource when the reservation result information indicates that the first resource fails to be reserved, for example, the first resource has been reserved or occupied by another terminal device. The network device may coordinate, by using the reservation result information, grant-free resources actually reserved by different terminal devices, so that a probability that the terminal device sends data on a resource that conflicts with that of another terminal device can be reduced to reduce interference between terminal devices and increase a decoding success rate of the network device, thereby improving reliability and efficiency.

Case 3: The reservation result information indicates that there is an unavailable first resource, that is, the first resource fails to be reserved. In this case, a resource in the grant-free resource other than the first resource is a third resource. In this case, optionally, the terminal device may select one or more resources from the third resource to send the data. In other words, the actually reserved grant-free resource is one or more resources in the third resource. Alternatively, the terminal device may re-reserve a resource in the third resource. For re-reserving, by the terminal device, the resource in the third resource, refer to the implementation of the first resource. Details are not described herein again.

As shown in FIG. 15, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the first resource fails to be reserved, and the resource q+7 is an unavailable resource, the third resource may include the resource q, the resource q+5, and the resource q+6. The actually reserved grant-free resource may include one or more of the following resources: the resource q, the resource q+5, or the resource q+6.

Optionally, the terminal device may re-reserve a resource in the resource q, the resource q+5, and the resource q+6. In this case, the actually reserved grant-free resource is one or more of re-reserved resources.

Alternatively, the terminal device may no longer reserve a resource, but directly determine, from the third resource, a resource used to send data. In this case, the actually reserved grant-free resource is a resource in the third resource.

In this way, when the first resource is unavailable, the third resource may be used to send data, so that a probability that the terminal device sends data on a resource that conflicts with that of another terminal device can be reduced to reduce interference between terminal devices and increase a decoding success rate of the network device, thereby improving reliability and efficiency.

Manner 2: The reservation result information indicates an unavailable grant-free resource in the grant-free resource.

Case 4: If all first resources are available grant-free resources, the first resource is successfully reserved. In this case, the actually reserved grant-free resource is the first resource.

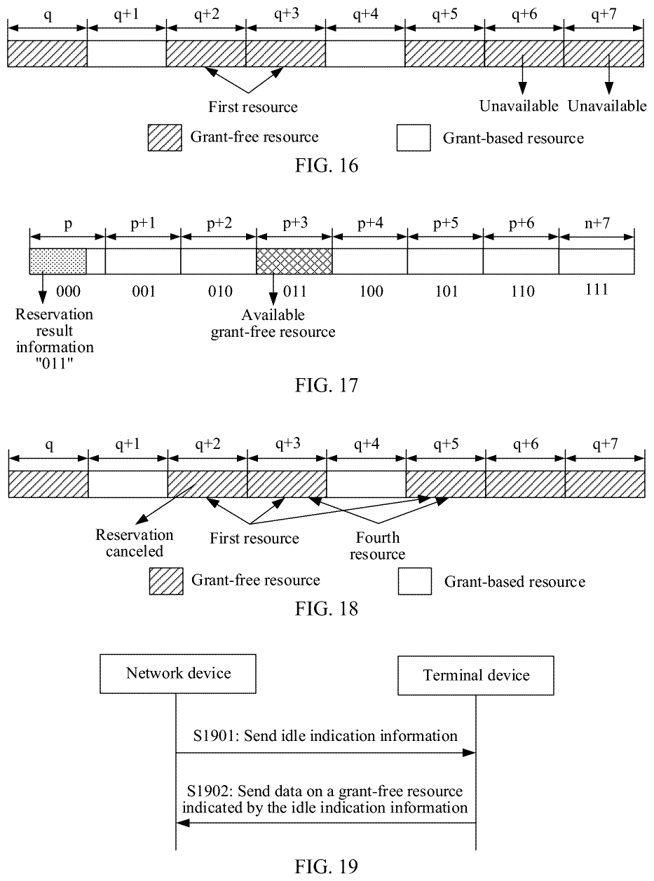

As shown in FIG. 16, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the reservation result information indicates that the resource q+6 and the resource q+7 are unavailable, the first resource is successfully reserved.

In this way, when the first resource is successfully reserved, the terminal device can send data on the first resource, so that a probability that the terminal device sends data on a resource that conflicts with that of another terminal device can be reduced to reduce interference between terminal devices and increase a decoding success rate of the network device, thereby improving reliability and efficiency.

Case 5: If the first resource includes an unavailable grant-free resource, the first resource fails to be reserved. In this case, the second resource is a resource other than the unavailable grant-free resource in the grant-free resource, and the actually reserved grant-free resource is a resource in the second resource.

In this way, the terminal device may receive the reservation result information, and send data on the second resource when the reservation result information indicates that the first resource fails to be reserved, for example, the first resource has been reserved or occupied by another terminal device. The network device may coordinate, by using the reservation result information, grant-free resources actually reserved by different terminal devices, so that a probability that the terminal device sends data on a resource that conflicts with that of another terminal device can be reduced to reduce interference between terminal devices and increase a decoding success rate of the network device, thereby improving reliability and efficiency.

An implementation principle of Case 5 is similar to an implementation principle of Case 2, and details are not described herein.

It should be noted that, in this embodiment of this disclosure, if there is a mapping relationship between a grant-free resource and a HARQ process, for example, the grant-free resource can be determined based on a HARQ process number, the reservation result information may also indicate an available HARQ process number to indicate an available grant-free resource, or the reservation result information may also indicate an unavailable HARQ process number to indicate an unavailable grant-free resource.

The following uses an example to describe a grant-free resource indicated by the reservation result information.

### Example 3: The Reservation Result Information May Indicate an Available Grant-Free Resource and/or an Unavailable Grant-Free Resource by Using a Bit Field (or Indicator Field)

For example, the reservation result information may include a bit field, and the bit field may indicate an unavailable grant-free resource or an available grant-free resource. Alternatively, the reservation result information may include two bit fields. One bit field indicates an available grant-free resource, and the other bit field indicates an unavailable grant-free resource. As shown in FIG. 17, if the reservation result information indicates an available grant-free resource, and a status of a bit field corresponding to the reservation result information is “011”, the available grant-free resource indicated by the reservation result information is a grant-free resource in a first resource periodicity p+3. For implementation in which the reservation result information indicates an available grant-free resource or an unavailable grant-free resource by using a bit field, refer to the implementation in which the resource reservation information indicates a grant-free resource in FIG. 8. Details are not described herein again.

### Example 4: The Reservation Result Information Indicates an Available Grant-Free Resource and an Unavailable Grant-Free Resource by Using a Bitmap

In this case, each bit corresponds to one grant-free resource. In other words, a status of each bit may indicate whether a grant-free resource corresponding to the bit is available.

For example, if the bit is “0”, it may indicate that the grant-free resource corresponding to the bit is unavailable; or if the bit is “1”, it may indicate that the grant-free resource corresponding to the bit is available. For example, in the reservation result information, if a bitmap corresponding to a first resource periodicity p to a first resource periodicity p+7 is “00001111”, grant-free resources in the first resource periodicity p to the first resource periodicity p+3 are all unavailable, and grant-free resources in the first resource periodicity p+4 to the first resource periodicity p+7 are all available.

A correspondence between a bit in the bitmap and a grant-free resource may be agreed on in a protocol, or may be configured by the network device for the terminal device by using an RRC message, a MAC CE, or DCI. For example, the network device may divide the grant-free resource into a plurality of first resource periodicities, and configure an association relationship between a bit in the bitmap and the first resource periodicity.

In a solution, the reservation result information may be implemented in an explicit manner. For example, the reservation result information may be carried in one or more of the following: control signaling, a control channel, or a data channel.

The control signaling used to carry the reservation result information may be DCI. The DCI may be carried in a PDCCH or a PDSCH. For example, the DCI is a HARQ-ACK. When performing HARQ-ACK feedback on received data, the network device may carry the reservation result information.

The control channel may be a PDCCH. In other words, the reservation result information may be carried in the PDCCH.

The data channel may be a PDSCH. Optionally, the reservation result information may be carried in a MAC CE. For example, when sending data 5 to the terminal device by using the PDSCH, the network device adds the grant-free resource reservation information to a MAC CE of the data 5, to reserve a grant-free resource to be used for transmitting next data (data 6). It may be understood that, in this embodiment of this disclosure, the PDSCH used to send the data 5 may be a PDSCH carrying Msg2, carrying Msg4, or carrying MsgA, or may be an SPS PDSCH or a dynamically scheduled PDSCH.

Alternatively, the reservation result information may be used as control plane data, for example, dedicated control channel (DCCH) data, and is mapped to a PDSCH.

In this way, when the first resource is unavailable, the third resource may be used to send data, so that a probability that the terminal device sends data on a resource that conflicts with that of another terminal device can be reduced to reduce interference between terminal devices, thereby improving reliability.

In another solution, the reservation result information may be implemented in an implicit manner. For example, the reservation result information may be associated with one or more of the following: a time domain resource, a frequency domain resource, a space domain resource, a beam domain resource, a code domain resource, a sequence resource, or a power domain resource.

The code domain resource may include one or more of the following: a spread spectrum sequence, a non-orthogonal multiple access signature, or a sparse mapping sequence. The sequence resource may include one or more of the following: a DMRS sequence, a preamble sequence, or a sequence corresponding to another reference signal. In this way, when the reservation result information is sent, an additional time-frequency resource may be avoided from being occupied, and the reservation result information is implicitly indicated, so as to reduce resource overheads, thereby further improving efficiency.

It may be understood that the reservation result information may be further implemented by combining an explicit manner and an implicit manner. For example, one part of the reservation result information may be transmitted in an explicit manner, and the other part of the reservation result information may be transmitted in an implicit manner. In this way, flexibility may be improved.

It should be noted that, in this embodiment of this disclosure, all the foregoing examples are described by using an example in which one piece of resource reservation information corresponds to one piece of reservation result information. During implementation, the reservation result information may correspond to one or more pieces of resource reservation information of one terminal device, or may correspond to resource reservation information of a plurality of terminal devices. It is assumed that when the DCI is used to carry the reservation result information, if the DCI corresponds to a plurality of terminal devices, the DCI may include an indication information field of one or more pieces of reservation result information. For example, the DCI includes a plurality of indication information fields, the plurality of indication information fields respectively correspond to different terminal devices, and a correspondence between an indication information field and a terminal device may be agreed on in a protocol or configured by the network device.

In addition, reservation result information respectively corresponding to a plurality of pieces of resource reservation information may be sent together. For example, the reservation result information respectively corresponding to the plurality of pieces of resource reservation information may be carried in a same data packet. In this case, optionally, reservation result information respectively corresponding to different resource reservation information corresponds to different bit fields. In other words, an association relationship between the reservation result information and the resource reservation information is implicitly indicated by using a bit field. For example, the reservation result information corresponds to resource reservation information 1 to resource information 3. A 0^{th} bit to a 3^{rd} bit in the reservation result information correspond to reservation result information of the resource reservation information 1, a 4^{th} bit to a 7^{th} bit in the reservation result information correspond to reservation result information of the resource reservation information 2, and an 8^{th} bit to an 11^{th} bit in the reservation result information correspond to reservation result information of the resource reservation information 3.

Alternatively, a correspondence between the resource reservation information and the reservation result information may be indicated in an explicit manner. For example, the correspondence between the resource reservation information and the reservation result information may be indicated by using one bit field, and the reservation result information is carried by using another bit field.

It should be noted that, in this embodiment of this disclosure, the reservation result information may be sent separately, or may be sent together with other data.

In a solution, after the terminal device sends the resource reservation information, in a scenario in which the terminal device determines that the network device configures a resource in the first resource to be used for grant-based transmission, the communication method shown in FIG. 7 may further include step 2.

Step 2: The terminal device sends first reservation cancellation information to the network device.

The first reservation cancellation information indicates a resource, whose reservation is canceled, in the first resource.

In this case, if the first resource is successfully reserved, in the grant-free resource, an available resource other than the resource that is indicated by the first reservation cancellation information and whose reservation is canceled is a fourth resource. In other words, an available resource that is not canceled in the grant-free resource is the fourth resource, and the actually reserved grant-free resource is a resource in the fourth resource.

As shown in FIG. 18, it is assumed that in a resource q to a resource q+7, a grant-based resource includes a resource q+1 and a resource q+4, a grant-free resource includes a resource q, a resource q+2, a resource q+3, and a resource q+5 to a resource q+7, and the first resource includes the resource q+2 and the resource q+3. If the reservation result information indicates that the first resource is successfully reserved, and the first reservation cancellation information indicates that reservation of the resource q+2 is canceled, the fourth resource includes the resource q+3 and the resource q+5. The actually reserved grant-free resource is one or more of the following resources: the resource q+3 or the resource q+5.

In this way, the terminal device may perform grant-free transmission based on a usage status of the first resource. For example, when the first resource is used for grant-based transmission, the terminal device may send data on an available resource, that is, the fourth resource, so that a probability that the terminal device sends data on a resource that conflicts with that of another terminal device can be reduced to reduce interference between terminal devices and increase a decoding success rate of the network device, thereby further improving reliability.

It should be noted that step 2 may also be performed in a scenario in which resource indication information from the network device is received. The resource indication information indicates an available grant-free resource other than the first resource in the grant-free resource. In this case, the actually reserved grant-free resource may be a grant-free resource specified by the resource indication information.

The foregoing step 2 may also be performed in a process in which channel quality changes from poor to good. In this way, both reliability and decoding efficiency may be considered.

The foregoing step 2 may also be performed when a grant-free transmission service is completed. In this way, resource utilization may be improved.

Optionally, the first reservation cancellation information may be carried in one or more of the following: control signaling, a control channel, or a data channel, that is, the first reservation cancellation information may be transmitted in an explicit manner.

Alternatively, the first reservation cancellation information may be associated with one or more of the following: a time domain resource, a frequency domain resource, a space domain resource, a beam domain resource, a code domain resource, a sequence resource, or a power domain resource, that is, the first reservation cancellation information may also be transmitted in an implicit manner, to reduce resources and improve efficiency.

For implementation of the first reservation cancellation information, refer to the implementation of the resource reservation information. Details are not described herein again.

It should be noted that the first reservation cancellation information may be further transmitted by combining an explicit manner and an implicit manner. For example, one part of the first reservation cancellation information may be transmitted in an explicit manner, and the other part of the first reservation cancellation information may be transmitted in an implicit manner. In this way, flexibility may be improved.

In another solution, after the terminal device sends the resource reservation information, if the first resource reserved by using the resource reservation information conflicts with a grant-free resource actually reserved by another terminal device, the communication method shown in FIG. 7 may further include step 3.

Step 3: The network device sends second reservation cancellation information to the terminal device.

The second reservation cancellation information indicates a resource, whose reservation is canceled, in the first resource.

In this case, if the first resource is successfully reserved, in the grant-free resource, an available resource other than the resource that is indicated by the second reservation cancellation information and whose reservation is canceled is a fifth resource. In other words, an available resource that is not canceled in the grant-free resource is the fifth resource, and the actually reserved grant-free resource is a resource in the fifth resource.

In this way, the terminal device may perform grant-free transmission based on a usage status of the first resource. For example, when the first resource corresponding to the terminal device conflicts with a grant-free resource reserved by another terminal device, the conflicting resource may be canceled, and data may be sent on an available resource in the first resource, that is, the fifth resource, so that a probability that the terminal device sends data on a resource that conflicts with that of another terminal device can be reduced to reduce interference between terminal devices and decrease a decoding success rate of the network device, thereby improving reliability.

Optionally, the second reservation cancellation information may be carried in one or more of the following: control signaling, a control channel, or a data channel, that is, the second reservation cancellation information may be transmitted in an explicit manner.

Alternatively, the second reservation cancellation information may be associated with one or more of the following: a time domain resource, a frequency domain resource, a space domain resource, a beam domain resource, a code domain resource, a sequence resource, or a power domain resource, that is, the second reservation cancellation information may also be transmitted in an implicit manner.

It should be noted that the second reservation cancellation information may be further transmitted by combining an explicit manner and an implicit manner. For example, one part of the second reservation cancellation information may be transmitted in an explicit manner, and the other part of the second reservation cancellation information may be transmitted in an implicit manner. In this way, flexibility may be improved.

It should be noted that an implementation of the fifth resource is similar to that of the fourth resource, and details are not described herein again.

For implementation of the second reservation cancellation information, refer to the implementation of the reservation result information. Details are not described herein again.

In still another solution, to-be-canceled grant-free resource may be determined based on a scheduling status of a grant-free resource.

For example, if the network device configures the terminal device to perform grant-free transmission by using a grant-based resource in the first resource, reservation of the grant-free resource is canceled. For example, if the first resource includes a grant-free resource corresponding to a HARQ process 1 and a grant-free resource corresponding to a HARQ process 2, before performing grant-free transmission, the terminal device receives DCI delivered by the network device, where the DCI indicates the terminal device to perform dynamic grant-based transmission by using the HARQ process 1. In this case, the terminal device cancels the reserved grant-free resource corresponding to the HARQ process 1.

It should be noted that, in this embodiment of this disclosure, the actually reserved grant-free resource may be determined jointly based on the resource reservation information, the reservation result information, and reservation cancellation information. In this case, if the first resource is successfully reserved, the actually reserved grant-free resource is related to the resource reservation information, the reservation result information, and the reservation cancellation information (the first reservation cancellation information or the second reservation cancellation information); or if the first resource fails to be reserved, the actually reserved grant-free resource is related to the resource reservation information and the reservation result information.

For example, the grant-free resource includes a resource 0 to a resource 7, and the first resource includes the resource 1 to the resource 5. If the reservation result information indicates that the first resource is successfully reserved, and the first reservation cancellation information indicates that resources whose reservation is canceled are the resource 2 and the resource 3, the actually reserved grant-free resource is one or more of the resource 1, the resource 4, and the resource 5.

If the reservation result information indicates that the first resource fails to be reserved, and the resource 6 and the resource 7 are available, the actually reserved grant-free resource is one or more of the resource 6 and the resource 7.

S702: The terminal device sends data on the actually reserved grant-free resource, and the network device receives the data on the actually reserved grant-free resource.

For example, the data sent by the terminal device on the actually reserved grant-free resource or the data received by the network device on the actually reserved grant-free resource may be one or more of the following: user plane (UP) data such as an disclosure-layer data packet, control plane (CP) data such as an RRC message, and another type of data or signal. For example, the another type of data or signal may be one or more of the following: UCI (for example, a scheduling request (SR), channel state information (CSI), and HARQ feedback), a reference signal, a pilot signal, and information (for example, gradient information, training data, and a model parameter) used for artificial intelligence (AI) or machine learning (ML). It may be understood that data sent by the terminal device on the actually reserved grant-free resource may be data transmitted for the first time, or may be retransmission or repetition of sent data.

Optionally, S702 in which the terminal device sends data on the actually reserved grant-free resource, and the network device receives data on the actually reserved grant-free resource may include the following:

If the actually reserved grant-free resource is the first resource, the terminal device sends the data on the first resource, and the network device receives the data on the first resource.

If the actually reserved grant-free resource is the second resource, the terminal device sends the data on the second resource, and the network device receives the data on the second resource. For example, the terminal device may select one or more resources from the second resource, to send the data on the selected resource.

If the actually reserved grant-free resource is the third resource, the terminal device sends the data on the third resource, and the network device receives the data on the third resource. For example, the terminal device may select one or more resources from the third resource, to send the data on the selected resource.

If the actually reserved grant-free resource is the fourth resource, the terminal device sends the data on the fourth resource, and the network device receives the data on the fourth resource. For example, the terminal device may select one or more resources from the fourth resource, to send the data on the selected resource.

If the actually reserved grant-free resource is the fifth resource, the terminal device sends the data on the fifth resource, and the network device receives the data on the fifth resource. For example, the terminal device may select one or more resources from the fifth resource, to send the data on the selected resource.

It should be noted that, in this embodiment of this disclosure, a time domain location of the resource reservation information is before a time domain location of the reservation cancellation information.

Based on the communication method shown in FIG. 7, the terminal device may send the resource reservation information to the network device to reserve the grant-free resource, and send data on the actually reserved grant-free resource. In this way, the network device may receive data from the terminal device based on the grant-free resource actually reserved by the terminal device. For example, the network device may receive data from the terminal device on the grant-free resource actually reserved by the terminal device, to avoid performing blind detection on all grant-free resources. This can reduce a quantity of blind detection times and reduce complexity of blind detection, so as to reduce a workload of blind detection, thereby reducing resource overheads and improving decoding efficiency.

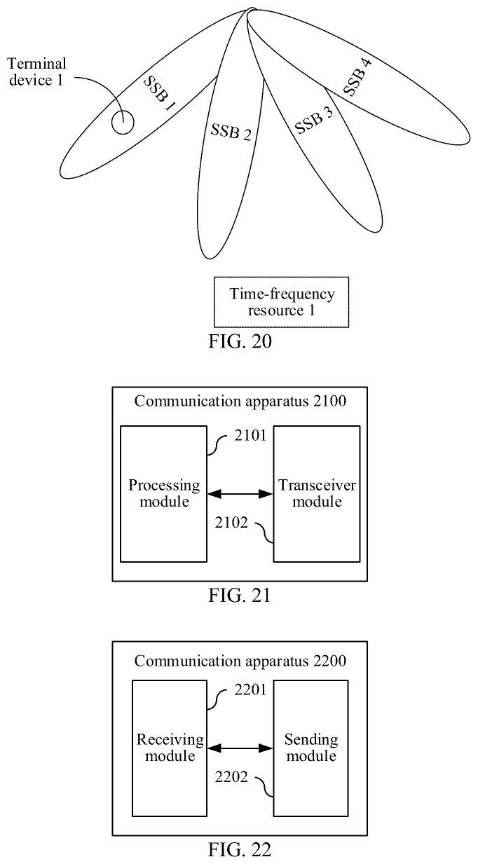

Another embodiment of this disclosure further provides a communication method. The following describes, with reference to FIG. 19 and FIG. 20, the communication method provided in this embodiment of this disclosure. For example, FIG. 19 is a second flowchart of a communication method according to an embodiment of this disclosure. The communication method is applicable to communication between the network device and the terminal device shown in FIG. 4 or FIG. 5. The communication method shown in FIG. 19 includes the following steps.

S1901: A network device sends idle indication information, and a terminal device receives the idle indication information.

The idle indication information indicates an available grant-free resource.

In a solution, the idle indication information may indicate an available grant-free resource.

In another solution, the idle indication information may indicate an unavailable grant-free resource, to indicate an available grant-free resource. In this case, the available grant-free resource is a resource other than the unavailable grant-free resource in a grant-free resource.

In still another solution, the idle indication information may indicate an available grant-free resource and an unavailable grant-free resource.

In a solution, the idle indication information may be carried in one or more of the following: control signaling, a control channel, or a data channel, that is, the idle indication information may be implemented in an explicit manner.

In another solution, the idle indication information may be associated with one or more of the following: a time domain resource, a frequency domain resource, a space domain resource, a beam domain resource, a code domain resource, a sequence resource, or a power domain resource, that is, the idle indication information may be implemented in an implicit manner.

In this way, when the idle indication information is sent, an additional time-frequency resource may be avoided from being occupied, and the idle indication information is implicitly indicated, so as to reduce resource overheads, thereby further improving efficiency.

It should be noted that the idle indication information may be further transmitted by combining an explicit manner and an implicit manner. For example, one part of the idle indication information may be transmitted in an explicit manner, and the other part of the idle indication information may be transmitted in an implicit manner. In this way, flexibility may be improved.

For implementation of the idle indication information, refer to the implementation of the reservation result information in the communication method shown in FIG. 7. Details are not described herein again.

It should be noted that, in this embodiment of this disclosure, the network device may periodically send the idle indication information. For example, the idle indication information may be carried in broadcast information, and the network device periodically sends the broadcast information to send the idle indication information.

S1902: The terminal device sends data on the grant-free resource indicated by the idle indication information, and the network device receives the data on the grant-free resource indicated by the idle indication information.

For example, the data may be carried in one or more of the following: a data channel such as a PUSCH, a control channel such as a PUCCH, a random access channel such as a PRACH, or a physical layer signal such as a reference signal. For example, in 2-step random access, data may be carried in the PRACH and the PUSCH.

For implementation of step S1902, refer to the implementation of S702 in the communication method shown in FIG. 7. Details are not described herein again.

For ease of understanding, the following describes, with reference to a time-frequency resource and a beam resource, the communication method shown in FIG. 19.

It is assumed that the network device configures, for a terminal device in a cell, information about a time-frequency resource and an associated beam resource that are used for grant-free transmission, for example, information about a synchronization signal block (SSB) (the SSB is subsequently used to represent the beam resource). One time-frequency resource may be associated with one or more SSBs.

FIG. 20 is a diagram of a relationship between a temporarily scheduled terminal device and a beam. As shown in FIG. 20, an SSB corresponding to a network device includes an SSB 1 to an SSB 4, a terminal device 1 is temporarily scheduled to send data on a time-frequency resource 1, and a beam direction of the terminal device 1 overlaps that of one of the SSB 1 to the SSB 4, for example, the SSB 1. In this case, to avoid interference, the network device may send idle indication information to a terminal device in a cell, to indicate that a beam resource corresponding to the SSB1 on the time-frequency resource 1 is unavailable. After receiving the idle indication information, a terminal device, such as a terminal device 2, other than the terminal device 1 in terminal devices in the cell may choose to perform grant-free transmission on a time-frequency resource other than the time-frequency resource 1 in a time-frequency resource. Alternatively, the terminal device 2 may choose to perform grant-free transmission on the time-frequency resource 1, but use pilot sequences mapped from the SSB2 to the SSB4, thereby reducing interference caused to the terminal device 1 temporarily scheduled by the network device.

Based on the communication method provided in FIG. 19, the network device sends the idle indication information to indicate the grant-free resource corresponding to the terminal device. In this way, the network device may receive data on the grant-free resource indicated by the idle indication information corresponding to each terminal device, to avoid performing blind detection on all grant-free resources. This can reduce a quantity of blind detection times and reduce complexity of blind detection, so as to reduce a workload of blind detection, thereby reducing resource overheads and improving decoding efficiency.

In addition, a probability that the terminal device sends data on a resource that conflicts with that of another terminal device may be further reduced to reduce interference and conflicts between different terminal devices, thereby increasing a decoding success rate and reliability of the network device.

It may be understood that the preamble sequence mapped to the SSB may alternatively be replaced with a DMRS sequence.

The communication methods provided in embodiments of this disclosure are described above in detail with reference to FIG. 6 to FIG. 20. Communication apparatuses configured to perform the communication methods provided in embodiments of this disclosure are described below in detail with reference to FIG. 21 to FIG. 23.

For example, FIG. 21 is a first diagram of a structure of a communication apparatus according to an embodiment of this disclosure. As shown in FIG. 21, the communication apparatus 2100 includes a processing module 2101 and a transceiver module 2102. For ease of description, FIG. 21 shows only main parts of the communication apparatus.

In some embodiments, the communication apparatus 2100 may be used in the communication system shown in FIG. 4 or FIG. 5, and performs a function of the terminal device in the communication method shown in FIG. 7.

The processing module 2101 is configured to control the transceiver module 2102 to send source reservation information, where the resource reservation information is used to reserve a grant-free resource.

The processing module 2101 is configured to control the transceiver module 2102 to send data on an actually reserved grant-free resource.

In a solution, the resource reservation information is carried in one or more of the following: control signaling, a control channel, or a data channel, that is, the resource reservation information may be transmitted in an explicit manner.

In another solution, the resource reservation information is associated with one or more of the following: a time domain resource, a frequency domain resource, a space domain resource, a beam domain resource, a code domain resource, a sequence resource, or a power domain resource, that is, the resource reservation information may also be transmitted in an implicit manner.

It should be noted that the resource reservation information may be further transmitted by combining an explicit manner and an implicit manner. For example, one part of the resource reservation information may be transmitted in an explicit manner, and the other part of the resource reservation information may be transmitted in an implicit manner.

In a solution, the resource reservation information is used to reserve a first resource in the grant-free resource. The processing module 2101 is configured to control the transceiver module 2102 to receive reservation result information, where the reservation result information indicates that the first resource is successfully reserved. The processing module 2101 is configured to control the transceiver module 2102 to send the data on the first resource.

In another solution, the resource reservation information is used to reserve a first resource in the grant-free resource. The processing module 2101 is configured to control the transceiver module 2102 to receive reservation result information, where the reservation result information includes reservation failure indication information of the first resource and availability indication information, the availability indication information indicates a second resource, and the second resource is an available grant-free resource. The processing module 2101 is configured to control the transceiver module 2102 to send the data on the second resource.

In still another solution, the resource reservation information is used to reserve a first resource in the grant-free resource. The processing module 2101 is configured to control the transceiver module 2102 to receive reservation result information, where the reservation result information includes reservation failure indication information of the first resource. The processing module 2101 is configured to control the transceiver module 2102 to send the data on a third resource, where the third resource is a resource in the grant-free resource other than the first resource.

Optionally, the reservation result information may be carried in one or more of the following: control signaling, a control channel, or a data channel, that is, the reservation result information may also be transmitted in an explicit manner.

Alternatively, the reservation result information may be associated with one or more of the following: a time domain resource, a frequency domain resource, a space domain resource, a beam domain resource, a code domain resource, a sequence resource, or a power domain resource, that is, the reservation result information may also be transmitted in an implicit manner.

It should be noted that the reservation result information may be further transmitted by combining an explicit manner and an implicit manner. For example, one part of the reservation result information may be transmitted in an explicit manner, and the other part of the reservation result information may be transmitted in an implicit manner.

In a solution, the resource reservation information is used to reserve a first resource in the grant-free resource. The processing module 2101 is further configured to control the transceiver module 2102 to send first reservation cancellation information, where the first reservation cancellation information indicates a resource, whose reservation is canceled, in the first resource.

The processing module 2101 is further configured to control the transceiver module 2102 to send the data on the fourth resource, where the fourth resource is a resource in the grant-free resource other than the resource whose reservation is canceled.

Optionally, the first reservation cancellation information may be carried in one or more of the following: control signaling, a control channel, or a data channel; and/or the first reservation cancellation information may be associated with one or more of the following: a time domain resource, a frequency domain resource, a space domain resource, a beam domain resource, a code domain resource, a sequence resource, or a power domain resource.

In a solution, the resource reservation information is used to reserve a first resource in the grant-free resource. The processing module 2101 is further configured to control the transceiver module 2102 to receive second reservation cancellation information, where the second reservation cancellation information indicates a resource, whose reservation is canceled, in the first resource.

The processing module 2101 is further configured to control the transceiver module 2102 to send the data on a fifth resource, where the fifth resource is a resource in a provided resource other than the resource whose reservation is canceled.

Optionally, the second reservation cancellation information may be carried in one or more of the following: control signaling, a control channel, or a data channel, that is, the second reservation cancellation information may be transmitted in an explicit manner.

Alternatively, the second reservation cancellation information may be associated with one or more of the following: a time domain resource, a frequency domain resource, a space domain resource, a beam domain resource, a code domain resource, a sequence resource, or a power domain resource, that is, the second t reservation cancellation information may also be transmitted in an implicit manner.

It should be noted that the second reservation cancellation information may be further transmitted by combining an explicit manner and an implicit manner. For example, one part of the second reservation cancellation information may be transmitted in an explicit manner, and the other part of the second reservation cancellation information may be transmitted in an implicit manner.

In a solution, the actually reserved grant-free resource is related to a status of a resource in the grant-free resource.

Optionally, the transceiver module 2102 may include a receiving module and a sending module (not shown in FIG. 21). The transceiver module is configured to implement a sending function and a receiving function of the communication apparatus 2100.

Optionally, the communication apparatus 2100 may further include a storage module (not shown in FIG. 21), and the storage module stores a program or instructions. When the processing module 2101 executes the program or the instructions, the communication apparatus 2100 is enabled to perform a function of the terminal device in the communication method shown in any one of the designs of FIG. 7.

It should be understood that, the processing module 2101 in the communication apparatus 2100 may be implemented by a processor or a processor-related circuit component, and may be a processor or a processing unit; and the transceiver module 2102 may be implemented by a transceiver or a transceiver-related circuit component, and may be a transceiver or a transceiver unit.

It should be noted that, the communication apparatus 2100 may be a terminal device, may be a chip (system) or another part or component that can be disposed in a terminal device, or may be an apparatus including a terminal device. This is not limited in this disclosure.

In addition, for technical effects of the communication apparatus 2100, refer to the technical effects of the communication method shown in any one of the designs of FIG. 7. Details are not described herein again.

In some other embodiments, the communication apparatus 2100 may be used in the communication system shown in FIG. 4 or FIG. 5, and performs a function of the network device in the communication method shown in FIG. 7.

The processing module 2101 is configured to control the transceiver module 2102 to receive resource reservation information, where the resource reservation information is used to reserve a grant-free resource.

The processing module 2101 is configured to control the transceiver module 2102 to receive data on an actually reserved grant-free resource.

In a solution, the resource reservation information is carried in one or more of the following: control signaling, a control channel, or a data channel, that is, the resource reservation information may be transmitted in an explicit manner. In another solution, the resource reservation information is associated with one or more of the following: a time domain resource, a frequency domain resource, a space domain resource, a beam domain resource, a code domain resource, a sequence resource, or a power domain resource, that is, the resource reservation information may also be transmitted in an implicit manner.

It should be noted that the resource reservation information may be further transmitted by combining an explicit manner and an implicit manner. For example, one part of the resource reservation information may be transmitted in an explicit manner, and the other part of the resource reservation information may be transmitted in an implicit manner.

In a solution, the resource reservation information is used to reserve a first resource in the grant-free resource. The processing module 2101 is configured to control the transceiver module 2102 to send reservation result information, where the reservation result information indicates that the first resource is successfully reserved. The processing module 2101 is configured to control the transceiver module 2102 to receive the data on the first resource.

In another solution, the resource reservation information is used to reserve a first resource in the grant-free resource. The processing module 2101 is configured to control the transceiver module 2102 to send reservation result information, where the reservation result information includes reservation failure indication information of the first resource and availability indication information, the availability indication information indicates a second resource, and the second resource is an available grant-free resource. The processing module 2101 is configured to control the transceiver module 2102 to receive the data on the second resource.

In still another solution, the resource reservation information is used to reserve a first resource in the grant-free resource. The processing module 2101 is configured to control the transceiver module 2102 to send reservation result information, where the reservation result information includes reservation failure indication information of the first resource. The processing module 2101 is configured to control the transceiver module 2102 to receive the data on a third resource, where the third resource is a resource in the grant-free resource other than the first resource.

Optionally, the reservation result information may be carried in one or more of the following: control signaling, a control channel, or a data channel, that is, the reservation result information may be transmitted in an explicit manner.

Alternatively, the reservation result information may be associated with one or more of the following: a time domain resource, a frequency domain resource, a space domain resource, a beam domain resource, a code domain resource, a sequence resource, or a power domain resource, that is, the reservation result information may also be transmitted in an implicit manner.

It should be noted that the reservation result information may be further transmitted by combining an explicit manner and an implicit manner. For example, one part of the reservation result information may be transmitted in an explicit manner, and the other part of the reservation result information may be transmitted in an implicit manner.

In a solution, the resource reservation information is used to reserve a first resource in the grant-free resource. The processing module 2101 is further configured to control the transceiver module 2102 to receive first reservation cancellation information, where the first reservation cancellation information indicates a resource, whose reservation is canceled, in the first resource. The processing module 2101 is further configured to control the transceiver module 2102 to receive the data on a fourth resource, where the fourth resource is a resource in the grant-free resource other than the resource whose reservation is canceled.

Optionally, the first reservation cancellation information may be carried in one or more of the following: control signaling, a control channel, or a data channel, that is, the first reservation cancellation information may be transmitted in an explicit manner.

Alternatively, the first reservation cancellation information may be associated with one or more of the following: a time domain resource, a frequency domain resource, a space domain resource, a beam domain resource, a code domain resource, a sequence resource, or a power domain resource, that is, the first reservation cancellation information may also be transmitted in an implicit manner.

It should be noted that the first reservation cancellation information may be further transmitted by combining an explicit manner and an implicit manner. For example, one part of the first reservation cancellation information may be transmitted in an explicit manner, and the other part of the first reservation cancellation information may be transmitted in an implicit manner.

In a solution, the resource reservation information is used to reserve a first resource in the grant-free resource. The processing module 2101 is further configured to control the transceiver module 2102 to send second reservation cancellation information, where the second reservation cancellation information indicates a resource, whose reservation is canceled, in the first resource. The processing module 2101 is further configured to control the transceiver module 2102 to receive the data on a fifth resource, where the fifth resource is a resource in a provided resource other than the resource whose reservation is canceled.

Optionally, the second reservation cancellation information may be carried in one or more of the following: control signaling, a control channel, or a data channel, that is, the second reservation cancellation information may be transmitted in an explicit manner.

Alternatively, the second reservation cancellation information may be associated with one or more of the following: a time domain resource, a frequency domain resource, a space domain resource, a beam domain resource, a code domain resource, a sequence resource, or a power domain resource, that is, the second reservation cancellation information may also be transmitted in an implicit manner.

It should be noted that the second reservation cancellation information may be further transmitted by combining an explicit manner and an implicit manner. For example, one part of the second reservation cancellation information may be transmitted in an explicit manner, and the other part of the second reservation cancellation information may be transmitted in an implicit manner.

In a solution, the actually reserved grant-free resource is related to a status of a resource in the grant-free resource.

Optionally, the transceiver module 2102 may include a receiving module and a sending module. The transceiver module 2102 is configured to implement a sending function and a receiving function of the communication apparatus 2100.

Optionally, the communication apparatus 2100 may further include a storage module (not shown in FIG. 21), and the storage module stores a program or instructions. When the processing module 2101 executes the program or the instructions, the communication apparatus 2100 is enabled to perform a function of the network device in the communication method shown in FIG. 7.

It should be understood that, the processing module 2101 in the communication apparatus 2100 may be implemented by a processor or a processor-related circuit component, and may be a processor or a processing unit; and the transceiver module 2102 may be implemented by a transceiver or a transceiver-related circuit component, and may be a transceiver or a transceiver unit.

It should be noted that, the communication apparatus 2100 may be the network device shown in FIG. 4 or FIG. 5, may be a chip (system) or another part or component disposed in the network device, or an apparatus including the network device. This is not limited in this embodiment of this disclosure.

In addition, for technical effects of the communication apparatus 2100, respectively refer to the technical effects of the communication method shown in any one of the designs of FIG. 7. Details are not described herein again.

For example, FIG. 22 is a second diagram of a structure of a communication apparatus according to an embodiment of this disclosure. As shown in FIG. 22, the communication apparatus 2200 includes a receiving module 2201 and a sending module 2202. For ease of description, FIG. 22 shows only main parts of the communication apparatus.

In some embodiments, the communication apparatus 2200 may be used in the communication system shown in FIG. 4 or FIG. 5, and performs a function of the terminal device in the communication method shown in FIG. 19.

The receiving module 2201 is configured to receive idle indication information.

The idle indication information indicates an available grant-free resource.

The sending module 2202 is configured to send data on the grant-free resource indicated by the idle indication information.

In a solution, the idle indication information is carried in one or more of the following: control signaling, a control channel, or a data channel, that is, the idle indication information may be transmitted in an explicit manner.

In another solution, the idle indication information is associated with one or more of the following: a time domain resource, a frequency domain resource, a space domain resource, a beam domain resource, a code domain resource, a sequence resource, or a power domain resource, that is, the idle indication information may be transmitted in an implicit manner.

It should be noted that the idle indication information may be further transmitted by combining an explicit manner and an implicit manner. For example, one part of the idle indication information may be transmitted in an explicit manner, and the other part of the idle indication information may be transmitted in an implicit manner.

Optionally, the receiving module 2201 and the sending module 2202 may be integrated into one module, for example, a transceiver module (not shown in FIG. 22). The transceiver module is configured to implement a sending function and a receiving function of the communication apparatus 2200.

Optionally, the communication apparatus 2200 may further include a processing module (not shown in FIG. 22). The processing module is configured to implement a processing function of the communication apparatus 2200.

Optionally, the communication apparatus 2200 may further include a storage module (not shown in FIG. 22), and the storage module stores a program or instructions. When the processing module executes the program or the instructions, the communication apparatus 2200 is enabled to perform a function of the terminal device in the communication method shown in any one of the designs of FIG. 19. It should be understood that, the processing module in the communication apparatus 2200 may be implemented by a processor or a processor-related circuit component, and may be a processor or a processing unit; and the transceiver module may be implemented by a transceiver or a transceiver-related circuit component, and may be a transceiver or a transceiver unit.

It should be noted that, the communication apparatus 2200 may be a terminal device, may be a chip (system) or another part or component that can be disposed in a terminal device, or may be an apparatus including a terminal device. This is not limited in this disclosure.

In addition, for technical effects of the communication apparatus 2200, refer to the technical effects of the communication method shown in any one of the designs of FIG. 19. Details are not described herein again.

In some other embodiments, the communication apparatus 2200 may be used in the communication system shown in FIG. 4 or FIG. 5, and performs a function of the network device in the communication method shown in FIG. 19.

The sending module 2202 is configured to send idle indication information.

The idle indication information indicates an available grant-free resource.

The receiving module 2201 is configured to receive data on the grant-free resource indicated by the idle indication information.

In a solution, the idle indication information is carried in one or more of the following: control signaling, a control channel, or a data channel, that is, the idle indication information may be transmitted in an explicit manner.

In another solution, the idle indication information is associated with one or more of the following: a time domain resource, a frequency domain resource, a space domain resource, a beam domain resource, a code domain resource, a sequence resource, or a power domain resource, that is, the idle indication information may be transmitted in an implicit manner.

It should be noted that the idle indication information may be transmitted by combining an explicit manner and an implicit manner. For example, one part of the idle indication information may be transmitted in an explicit manner, and the other part of the idle indication information may be transmitted in an implicit manner.

Optionally, the receiving module 2201 and the sending module 2202 may be integrated into one module, for example, a transceiver module (not shown in FIG. 19). The transceiver module is configured to implement a sending function and a receiving function of the communication apparatus 2200.

Optionally, the communication apparatus 2200 may further include a processing module (not shown in FIG. 22). The processing module is configured to implement a processing function of the communication apparatus 2200.

Optionally, the communication apparatus 2200 may further include a storage module (not shown in FIG. 22), and the storage module stores a program or instructions. When the processing module executes the program or the instructions, the communication apparatus 2200 is enabled to perform a function of the network device in the communication method shown in FIG. 19.

It should be understood that, the processing module in the communication apparatus 2200 may be implemented by a processor or a processor-related circuit component, and may be a processor or a processing unit; and the transceiver module may be implemented by a transceiver or a transceiver-related circuit component, and may be a transceiver or a transceiver unit.

It should be noted that, the communication apparatus 2200 may be the network device shown in FIG. 4 or FIG. 5, may be a chip (system) or another part or component disposed in the network device, or an apparatus including the network device. This is not limited in this embodiment of this disclosure.

In addition, for technical effects of the communication apparatus 2200, respectively refer to the technical effects of the communication method shown in any one of the designs of FIG. 19. Details are not described herein again.

In addition, the processing module in the communication apparatus 2200 may be implemented by a processor or a processor-related circuit component, and may be a processor or a processing unit; and the transceiver module may be implemented by a transceiver or a transceiver-related circuit component, and may be a transceiver or a transceiver unit.

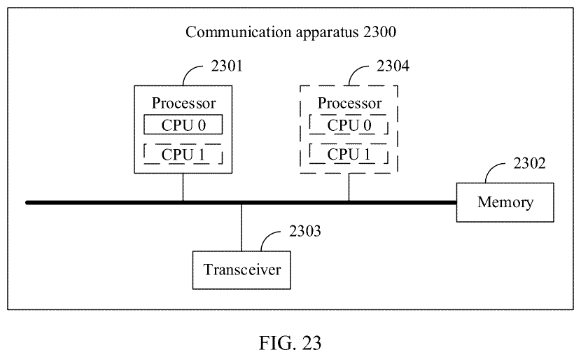

For example, FIG. 23 is a third diagram of a structure of a communication apparatus according to an embodiment of this disclosure. The communication apparatus may be a terminal device or a network device, or may be a chip (system) or another part of component that can be disposed in a terminal device or a network device. As shown in FIG. 23, the communication apparatus 2300 may include a processor 2301. Optionally, the communication apparatus 2300 may further include a memory 2302 and/or a transceiver 2303. The processor 2301 is coupled to the memory 2302 and the transceiver 2303, for example, may be connected by using a communication bus.

The following describes the components of the communication apparatus 2300 with reference to FIG. 23.

The processor 2301 is a control center of the communication apparatus 2300, and may be one processor, or may be a general term of a plurality of processing elements. For example, the processor 2301 is one or more central processing units (CPUs), or may be an application-specific integrated circuit (ASIC), or one or more integrated circuits configured to implement embodiments of this disclosure, for example, one or more microprocessors (e.g. digital signal processors (DSPs)) or one or more field programmable gate arrays (FPGAs).

Optionally, the processor 2301 may perform various functions of the communication apparatus 2300 by running or executing a software program stored in the memory 2302 and invoking data stored in the memory 2302.

In an implementation, in an embodiment, the processor 2301 may include one or more CPUs, for example, a CPU 0 and a CPU 1 shown in FIG. 23.

In an implementation, in an embodiment, the communication apparatus 2300 may alternatively include a plurality of processors, for example, the processor 2301 and a processor 2304 shown in FIG. 23. Each of the processors may be a single-core (single-CPU) processor or may be a multi-core (multi-CPU) processor. The processor herein may be one or more devices, circuits, and/or processing cores configured to process data (for example, computer program instructions).

The memory 2302 is configured to store a software program for performing the solutions in this disclosure, and the processor 2301 controls execution of the software program. For an implementation, refer to the foregoing method embodiments. Details are not described herein again.

Optionally, the memory 2302 may be a read-only memory (ROM) or another type of static storage device that can store static information and instructions, or a random access memory (RAM) or another type of dynamic storage device that can store information and instructions; or may be an electrically erasable programmable read-only memory (EEPROM), a compact disc read-only memory (CD-ROM) or another optical disk storage, an optical disc storage (including a compact disc, a laser disc, an optical disc, a digital versatile disc, a Blu-ray disc, or the like), a magnetic disk storage medium or another magnetic storage device, or any other medium that can be configured to carry or store expected program code in a form of instructions or a data structure and that can be accessed by a computer. However, this is not limited thereto. The memory 2302 may be integrated with the processor 2301, or may exist independently, and is coupled to the processor 2301 by using an interface circuit (not shown in FIG. 23) of the communication apparatus 2300. This is not limited in this embodiment of this disclosure.

The transceiver 2303 is configured to communicate with another communication apparatus. For example, the communication apparatus 2300 is a terminal device, and the transceiver 2303 may be configured to communicate with a network device or communicate with another terminal device. For another example, the communication apparatus 2300 is a network device, and the transceiver 2303 may be configured to communicate with a terminal device or communicate with another network device.

Optionally, the transceiver 2303 may include a receiver and a transmitter (not separately shown in FIG. 23). The receiver is configured to implement a receiving function, and the transmitter is configured to implement a sending function.

Optionally, the transceiver 2303 may be integrated with the processor 2301, or may exist independently, and is coupled to the processor 2301 by using an interface circuit (not shown in FIG. 23) of the communication apparatus 2300. This is not limited in this embodiment of this disclosure.

It should be noted that, the structure of the communication apparatus 2300 shown in FIG. 23 does not constitute a limitation on the communication apparatus. An actual communication apparatus may include more or fewer parts than those shown in the figure, or combine some parts, or have different part arrangements.

In addition, for technical effects of the communication apparatus 2300, refer to the technical effects of the communication method in the foregoing method embodiments. Details are not described herein again.

It should be understood that, the processor in embodiments of this disclosure may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It should be further understood that, the memory in embodiments of this disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. Through an example description rather than a limitative description, many forms of random access memories (RAMs) are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented by using software, hardware (for example, a circuit), firmware, or any other combination. When software is used for implementation, the foregoing embodiments may be entirely or partially implemented in a form of a computer program product. The computer program product includes one or more computer instructions or computer programs. When the computer instructions or the computer programs are loaded or executed on a computer, all or some of the procedures or functions according to embodiments of this disclosure are generated. The computer may be a general-purpose computer, a dedicated computer, a computer network, or another programmable apparatus. The computer instructions may be stored in a computer-readable storage medium, or may be transmitted from one computer-readable storage medium to another computer-readable storage medium. For example, the computer instructions may be transmitted from one website, computer, server, or data center to another website, computer, server, or data center in a wired (for example, infrared, radio, or microwave) manner. The computer-readable storage medium may be any available medium accessible to a computer, or a data storage device, such as a server or a data center, integrating one or more available media. The available medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects and represents that three relationships may exist. For example, “A and/or B” may represent the following three cases: Only A exists, both A and B exist, and only B exists, where A and B may be singular or plural. In addition, the character “/” in this specification usually indicates an “or” relationship between associated objects, but may also indicate an “and/or” relationship. For details, refer to the context for understanding.

In this disclosure, “at least one” means one or more, and “a plurality of” means two or more. “At least one of the following items” or a similar expression thereof means any combination of these items, including a singular item or any combination of plural items. For example, at least one of a, b, or c may indicate a, b, c, a-b, a-c, b-c, or a-b-c, where a, b, and c may be singular or plural.

It should be understood that, in various embodiments of this disclosure, sequence numbers of the foregoing processes do not mean execution sequences. The execution sequences of the processes should be determined by functions and internal logic of the processes, and shall not constitute any limitation on implementation processes of embodiments of this disclosure.

A person of ordinary skill in the art may be aware that, the units and the algorithm steps in the examples described with reference to embodiments disclosed in this specification can be implemented by electronic hardware or a combination of computer software and electronic hardware. Whether the functions are performed by hardware or software depends on particular disclosures and design constraint conditions of the technical solutions. A skilled person may use different methods to implement the described functions for each particular disclosure, but this implementation should not be considered as beyond the scope of this disclosure.

It may be clearly understood by a person skilled in the art that, for convenient and brief description, for working processes of the system, apparatus, and unit described above, refer to corresponding processes in the foregoing method embodiments. Details are not described herein again.

In the several embodiments provided in this disclosure, it should be understood that the disclosed system, apparatus, and method may be implemented in other manners. For example, the apparatus embodiments described above are merely examples. For example, division into the units is merely logical function division, and there may be another division manner in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or the units may be implemented in an electrical form, a mechanical form, or another form.

The units described as separate parts may or may not be physically separate, and parts displayed as units may or may not be physical units, that is, may be located in one place, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units may be integrated into one unit.

When the function is implemented in a form of a software functional unit and sold or used as an independent product, the function may be stored in a computer-readable storage medium. Based on such an understanding, the technical solutions in this disclosure essentially, or the part contributing to the conventional technology, or some of the technical solutions may be implemented in a form of a software product. The computer software product is stored in a storage medium and includes several instructions for instructing a computer device (which may be a personal computer, a server, a network device, or the like) to perform all or some of the steps of the methods in embodiments of this disclosure. The foregoing storage medium includes any medium that can store program code, such as a USB flash drive, a removable hard disk, a read-only memory (ROM), a random access memory (RAM), a magnetic disk, or an optical disc.

The foregoing descriptions are merely implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A method, comprising:
sending resource reservation information, the resource reservation information being used to reserve a grant-free resource; and
sending data on an actually reserved grant-free resource.

2. The communication method according to claim 1, wherein the resource reservation information is carried in one or more of: a control signaling, a control channel, or a data channel.

3. The communication method according to claim 1, wherein the resource reservation information is associated with one or more of: a time domain resource, a frequency domain resource, a space domain resource, a beam domain resource, a code domain resource, a sequence resource, or a power domain resource.

4. The communication method according to claim 1, wherein the actually reserved grant-free resource comprises a first resource when the first resource is successfully reserved.

5. The communication method according to claim 1, wherein the actually reserved grant-free resource comprises a second resource when the second resource is indicated as an available grant-free resource.

6. The communication method according to claim 1, wherein the resource reservation information is used to reserve a first resource in the grant-free resource, and the actually reserved grant-free resource comprises a third resource different from the first resource.

7. The method according to claim 1, further comprising:
receiving a reservation result information, where the reservation result information comprises one of: a first reservation failure indication of the grant-free resource, or a second reservation failure indication of the grant-free resource.

8. The method according to claim 7, where the reservation result information further comprises another available grant-free resource different from the grant-free resource in the resource reservation information.

9. The method according to claim 7, wherein the reservation result information is carried in one or more of: a control signaling, a control channel, or a data channel.

10. The method according to claim 7, wherein the reservation result information is associated with one or more of: a time domain resource, a frequency domain resource, a space domain resource, a beam domain resource, a code domain resource, a sequence resource, or a power domain resource.

11. The method according to claim 1, further comprising:
sending first reservation cancellation information, wherein the first reservation cancellation information indicates a resource whose reservation is canceled in the first resource.

12. The method according to claim 11, wherein the first reservation cancellation information is carried in one or more of: a control signaling, a control channel, or a data channel.

13. The method according to claim 11, wherein the first reservation cancellation information is associated with one or more of: a time domain resource, a frequency domain resource, a space domain resource, a beam domain resource, a code domain resource, a sequence resource, or a power domain resource.

14. The method according to claim 1, wherein the actually reserved grant-free resource is related to a status of a resource in the grant-free resource.

15. An apparatus, comprising:
a memory storing instructions; and
a processing circuit in communication with the memory, the processing circuit configured, upon execution of the instructions, to cause the apparatus to:
send resource reservation information, the resource reservation information being used to reserve a grant-free resource; and
send data on an actually reserved grant-free resource.

16. The apparatus according to claim 15, wherein the resource reservation information is carried in one or more of: a control signaling, a control channel, or a data channel.

17. The apparatus according to claim 15, wherein the resource reservation information is associated with one or more of: a time domain resource, a frequency domain resource, a space domain resource, a beam domain resource, a code domain resource, a sequence resource, or a power domain resource.

18. The apparatus according to claim 15, wherein the actually reserved grant-free resource comprises a first resource when the first resource is successfully reserved.

19. The apparatus according to claim 15, wherein the actually reserved grant-free resource comprises is a second resource when the second resource is indicated as an available grant-free resource.

20. A non-transitory computer-readable storage media storing computer instructions that configure at least one processor, upon execution of the instructions, to cause a computer to:
send resource reservation information, the resource reservation information being used to reserve a grant-free resource; and
send data on an actually reserved grant-free resource.
